(19) United States
(12) Patent Application Publication
(10) Pub. No.: US 2026/0210739 A1
(43) Pub. Date: Jul. 23, 2026

(54) ENCODER APPARATUS

(71) Applicant: RENISHAW PLC, Wotton-under-Edge, Gloucestershire (GB)

(72) Inventors: Jason Kempton SLACK, Wotton-under-Edge (GB); Theodore Richard REEVE, Wotton-under-Edge (GB); Alexander David STRONACH, Wotton-under-Edge (GB); Richard James BALE, Wotton-under-Edge (GB); David John MCCABE, Wotton-under-Edge (GB)

(73) Assignee: RENISHAW PLC, Wotton-under-Edge, Gloucestershire (GB)

(21) Appl. No.: 19/139,718

(22) PCT Filed: Dec. 15, 2023
(86) PCT No.: PCT/GB2023/053256

§ 371 Date: Jun. 16, 2025

(30) Foreign Application Priority Data
Dec. 20, 2022 (EP) 22275164.6
Dec. 20, 2022 (EP) 22275165.3
Dec. 20, 2022 (EP) 22275166.1
Dec. 21, 2022 (EP) 22275167.9

(51) Int. Cl. G01D 5/34; G01D 5/347; G01D 5/38

(52) U.S. Cl. CPC G01D 5/345; G01D 5/34715; G01D 5/38

(57) ABSTRACT

A position measurement encoder apparatus including: a scale including a series of position features which are readable by a readhead; and a readhead including: a polarised light source for emitting polarised light toward the scale; a first sensor configured to sense light filtered along a first polarisation axis, the first sensor being arranged to sense light from the polarised light source that has interacted with the scale; and a polarisation manipulator, located in the optical path between the polarised light source and the first sensor, configured such that regardless of the polarisation state of the light emitted from the polarised light source, light that leaves the polarisation manipulator toward the first sensor will have a polarisation state which is at least partially resolvable along the first polarisation axis.

This invention relates to a position measurement encoder apparatus.

A position measurement encoder apparatus (hereinafter referred to as an “encoder apparatus” or “position encoder”) can be used to determine movement of two relatively moveable parts of an apparatus. A position encoder typically comprises a scale and a readhead (one provided on one part of the apparatus and the other on the other part of the apparatus). The scale can comprise a series of features which the readhead can read so as to measure its position along the scale (the scale's features, for example, could be provided on a substrate which is fastened to the part of the apparatus, or could even be formed integrally as part of the apparatus).

A so-called “incremental” position encoder can work, for example, by “counting” its position along the length of the scale, e.g. from its start-up position and/or from a defined reference marker(s) on the scale. As will be understood, the way in which the “counting” of the readhead's position is done can vary from encoder apparatus to encoder apparatus. For example, one way is to generate a resultant field, such as an interference fringe field/pattern (“fringe field”), modulated spots, or image at a detector in the readhead, which changes with relative movement. For example, light from a source within the readhead can hit the scale which diffracts the light into a number of diffraction orders. The diffraction orders interfere/interact/recombine at the detector to produce the resultant field. Optionally, an optical element (for example a diffraction grating and/or lens) within the readhead can be provided which redirects/deflects diffraction orders such that they interfere/interact at the detector so as to produce the resultant field. As the scale and readhead move relative to each other, the resultant field changes. The readhead can record and/or report movement and position by monitoring the change of the resultant field (e.g. movement of the interference fringe pattern/fringe field). Such a position encoder is described in U.S. Pat. No. 5,861,953.

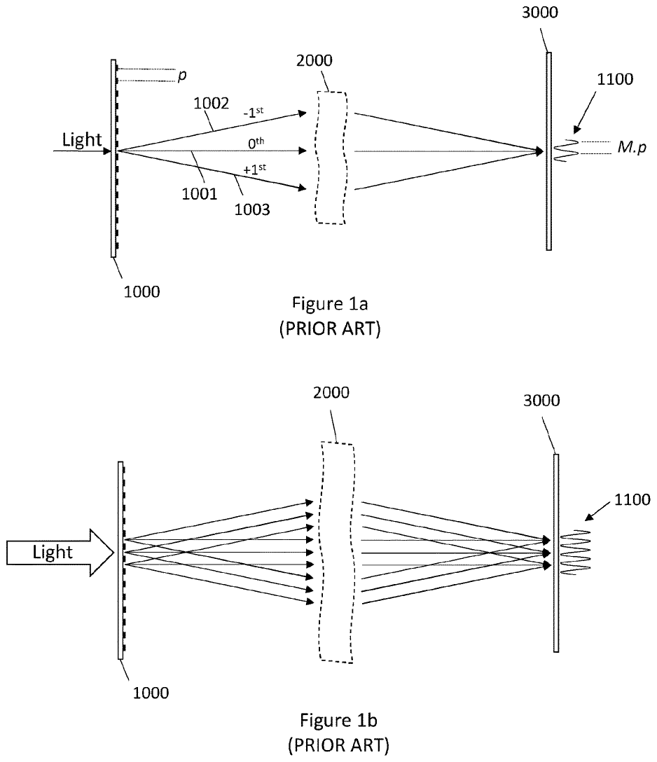

FIG. 1a schematically illustrates the optical workings of such a generic prior art incremental position encoder system. The scale 1000 has a periodic series of features having a period “p” is illuminated by light, thereby producing a set of diffraction orders 1001, 1002, 1003. As will be understood, references to light in this document include visible and non-visible light, from the ultraviolet to infra-red ranges. The diffraction orders 1001, 1002, 1003 are relayed to a sensor 3000 by a relay element 2000 (e.g. a lens, prism or a diffraction grating) (the sensor and relay element both being located in a readhead which is moveable relative to the scale 1000). The diffraction orders interfere at the sensor 3000, thereby producing an interference fringe pattern/field (schematically illustrated by the wave 1100) at the sensor 3000 having a period equal to M.p; where Mis the magnifying factor of the optical system and p is the scale period. In FIG. 1a, the light is shown as being transmitted through the scale, although as will be understood, the light could be reflected from the scale, and so could originate from a light source located on the same side of the scale as the sensor. As will be understood, typically, the source of the light, the relay element 2000 and the sensor 3000 are all provided by/in a readhead device which is configured to move relative to the scale 1000.

FIG. 1a is a simplified illustration of the optical situation encountered in an encoder apparatus. In reality, the optical situation shown in FIG. 1a is repeated many times over along the length of the scale (i.e. over the area that is illuminated by the source), producing a longer interference fringe field/pattern at the detector (e.g. schematically illustrated in FIG. 1b).

For illustrative purposes, only the 0^{th} and +/−1^{st} orders are shown in FIGS. 1a and 1b. As will be understood, higher diffraction orders will be produced, and can contribute to the formation of the fringe field at the sensor 3000, although their intensity and therefore contribution to the fringe field are typically much weaker than the 0^{th} and +/−1^{st} diffraction orders (with higher orders being progressively weaker in intensity).

As will be understood, where the mark-space ratio (i.e. the ratio of the width of the scale features to the spacing between the marks) of the scale is perfectly 1:1 (as is often the case with amplitude scale for an encoder apparatus), even diffraction orders (e.g. +/−2^{nd}, +/−4^{th} diffraction orders) will not be produced, and only odd diffraction orders will be produced (e.g. +/−3^{rd}, +/−5^{th} diffraction orders). In practice, some minor fabrication errors might mean that the mark-space ratio of the scale is not perfectly 1:1 and so even diffraction orders might be present (albeit likely having significantly less intensity than adjacent odd diffraction orders). As will be understood, where the mark-space ratio of the scale is deliberately formed such that it is not 1:1, then significant even diffraction orders can be present.

For the sake of simplicity of illustration, the ray diagrams of FIGS. 1a and 1b are shown as transmissive ray diagrams (that is the light is shown as being transmitted through each of the scale and optical relay element), whereas in reality at least one of these could be reflective.

As will be understood, reference marks can be provided, for instance next to and/or embedded within the scale's diffraction features, in order to provide defined reference positions. Such a position encoder is described in U.S. Pat. No. 7,659,992.

So-called “absolute” position encoders are also known which enable the absolute position of the readhead relative to a scale to be determined without the need to count from a predetermined position, such as a reference mark or an end position of the scale. Absolute position encoders typically comprise a scale with unique position data formed on it along the measuring length of the scale. The data can be in the form of, for instance, a pseudorandom sequence or discrete codewords. By reading this data as the scale reader passes over the scale, the scale reader can determine its absolute position. Examples of absolute position encoders are described in U.S. Pat. Nos. 7,499,827, 10,132,657 and US2012/0072169. It is known that some absolute encoders use incremental scales alongside absolute scales. It is also known (and for example described in U.S. Pat. No. 7,499,827) that, optionally, the absolute scale retains sufficient periodicity such that the scale can be used as a periodic incremental scale. Either way, such incremental scale can be used, for example, to fine-tune the determined absolute position. Optionally, such a system can be used such that after start-up and the absolute position has been determined, the relative position of the readhead and scale is subsequently measured by “counting” the change in position using the incremental scale. Such an incremental scale can be read in the same way as mentioned above, e.g. by analysing a resultant field produced (at a sensor in the readhead) by the diffraction orders created by the scale.

The present invention relates to an improved optical encoder.

According to a first aspect of the invention there is provided a position measurement encoder apparatus comprising: a scale comprising a series of position features which are readable by a readhead; a readhead comprising: a polarised light source for emitting polarised light toward the scale; a first sensor configured to sense light filtered along a first polarisation axis, the first sensor being arranged to sense light from the polarised light source that has interacted with the scale; a polarisation manipulator, located in the optical path between the polarised light source and the first sensor, configured such that regardless of the polarisation state of the light emitted from the polarised light source, light that leaves the polarisation manipulator toward the first sensor will have a polarisation state (e.g. (e.g. predominant) polarisation orientation) which is at least partially resolvable along the first polarisation axis.

As explained in more detail below, it can be beneficial that the first sensor is configured to sense light filtered along a first polarisation axis, because, for example, it can provide at least some level of control over what falls on the first sensor. This functionality can, for instance, be taken advantage of so as to improve the (quality of the) signal received by the first sensor.

At the same time, it is typical that optical encoders employ the use of non-polarised light sources. Indeed, at the time of writing, all optical encoders sold by Renishaw plc, utilise light emitting diodes (LEDs) which emit unpolarised light. However, the present invention provides an alternative optical encoder which utilises a polarised light source for emitting the light that illuminates the scale. Optionally, the light source emits linearly polarised light. For the purposes of this patent application, a polarised light source means a light source which emits light, the degree of polarisation of which is at least 0.2. (In other words, optionally, the degree of polarisation of the light emitted from the polarised light source is not less than 0.2). Similarly, for the purposes of this patent application, polarised light means light, the degree of polarisation of which is at least 0.2. The light source could comprise, for example, a laser light source, for instance a Vertical Cavity Surface-Emitting Laser (VCSEL). As will be understood by those skilled in the art, laser light sources such as VCSELs emit polarised light, for example typically having a degree of polarisation of at least 0.3 (typically between 0.3 and 0.7). Compared to LEDs, laser light sources can provide optical power benefits which has been found to provide metrological performance improvements, in particular reduced jitter due to reduced noise.

Optionally, the light source is a linearly polarised light source; in other words, optionally the light source emits linearly polarised light.

As will be understood, the “degree of polarisation” (or “DOP” as it will sometimes be referred to herein) of light is a simple metric which quantifies how polarised the light is. Completely unpolarised light has a DOP of 0 (or 0%) while completely/purely polarised light has a DOP of 1 (or 100%). The DOP of light can easily be measured experimentally as will now be described. The light is passed through a linear polariser and the outgoing light that has passed through the linear polariser falls on a photodetector. The linear polariser is rotated through 180 degrees and the optical power observed at the photodetector is measured (as the liner polariser is rotated). The optical power at the photodetector will vary with a sinusoidal pattern if the light has polarisation. The modulation of this sinusoid reveals the DOP. Accordingly:

$$DOP = \frac{max power - min power}{max power + min power} \qquad ( 1 )$$

As is well known, as well as linearly polarised light, light can be “circularly” polarised, or “elliptically” polarised. As will understood, circularly polarised light will, by the above measure, have a DOP of 0. Purely linearly polarised light will have a DOP of 1, and elliptically polarised light will have a DOP between 0 and 1 (not inclusive thereof), depending on how elliptical the elliptical polarised light is. As will be understood, linearly polarised light might not be “pure” or “purely” linearly polarised, and therefore linearly polarised light might not have a DOP of 1.

As will be understood, linear and elliptically polarised light (especially elliptically polarised light having a DOP of at least 0.2) will have a (e.g. predominant) polarisation orientation. Accordingly, it could be said that a the polarisation manipulator (which is located in the optical path between the polarised light source and the first sensor), is configured such that regardless of the (e.g. predominant) polarisation orientation of the light emitted from the polarised light source, light that leaves the polarisation manipulator toward the first sensor will have a (e.g. predominant) polarisation orientation which is at least partially resolvable along the first polarisation axis.

As mentioned above, as far as this invention is concerned, a polarised light source can be any light source which emits (e.g. linearly or elliptically polarised) light having a DOP of at least 0.2. However, of course, the DOP of the polarised light source could be higher. Indeed, the higher the DOP of the of the polarised light source the greater the benefit the polarisation manipulator can be.

Of course, due to the polarisation sensitive nature of the first sensor, and due to the polarisation of light from the source, there can be an issue with the first sensor not receiving sufficient (or even, any) light if the (e.g. predominant) polarisation orientation of the light is angled too much with respect to the first polarisation axis. Accordingly, the present invention provides a polarisation manipulator, located in the optical path between the polarised light source and the first sensor, configured such that regardless of the polarisation state of the light emitted from the polarised light source, light that leaves the polarisation manipulator toward the first sensor will have a polarisation state which is at least partially resolvable along the first polarisation axis (thereby ensuring that the first sensor will receive at least some light).

The apparatus, in particular the polarisation manipulator, can be configured such that of the light leaving the polarisation manipulator toward the first sensor, the ratio of: i) the optical power of light resolvable along the first polarisation axis, to ii) the optical power of light resolvable along a second orthogonal polarisation axis, is at least 2:3, more preferably at least 3:4, more preferably at least 4:5, for example at least 12:13.

Optionally, the apparatus is configured such that for all other factors being equal, the optical power of light sensed by the first sensor is substantially the same for all possible (e.g. predominant) polarisation orientations of the light emitted from the polarised light source.

The readhead can additionally comprise: a second sensor configured to sense light filtered along a second polarisation axis. The second sensor can be arranged to sense light from the polarised light source that has interacted with the scale. The polarisation manipulator can be configured such that regardless of the polarisation state (e.g. (e.g. predominant) polarisation orientation) of the light emitted from the polarised light source, light leaving the polarisation manipulator toward the second sensor will have a polarisation state (e.g. (e.g. predominant) polarisation orientation) which is at least partially resolvable along the second axis. It can be beneficial that the second polarisation axis is orthogonal to the first polarisation axis. For instance, this means that each of the first and second sensors can be blind to the light that the other sensor is sensitive to.

The apparatus can be configured such that, for all other factors being equal (e.g. for a constant output of optical power by the light source), the optical power of light sensed by the first sensor is substantially the same for all possible (e.g. predominant) polarisation orientations of the light emitted from the polarised light source, and the optical power of light sensed by the second sensor is substantially the same for all possible (e.g. predominant) polarisation orientations of the light emitted from the polarised light source. In other words, for all other factors being equal, the optical power of light sensed by the first sensor, and the optical power of light sensed by the second sensor is not dependent on the (e.g. predominant) polarisation orientations of the light emitted from the polarised light source. Substantially the same can mean that, if the optical power of light received by the first (or second) sensor is measured for all possible (e.g. predominant) polarisation orientations of light emitted by the light source, the change/variation in optical power of the light received by the first (or second) sensor will be no greater than 25% (more preferably no greater than 15%, for example no greater than 5%, for example no greater than 2%).

The polarisation manipulator could comprise a diffuser. Advantageously, the polarisation manipulator could comprise a waveplate (also known as a “retarder”). The waveplate can have a substantially uniform fast axis across its extent (at least across its extent through which light, that is received by the first sensor, and second sensor if present, passes). Advantageously, the effective total wave retardance of the polarisation manipulator can be n+¼, where n is an integer ≥0. Accordingly, in embodiments in which light passes through the waveplate once (in its path from the light source to the first sensor and second sensor, if present), then it can be advantageous that the waveplate is a quarter (¼) waveplate. In embodiments in which light passes through the waveplate twice (in its path from the light source to the first sensor and second sensor, if present), then it can be advantageous that the waveplate is an octadic (⅛) waveplate. Similarly, the polarisation manipulator could comprise two octadic (⅛) waveplates in the optical path from the light source to the first sensor (and second sensor if present), wherein the light passes through each of the two octadic (⅛) waveplates once.

It can be beneficial that the waveplate is arranged such that its fast axis is arranged at an angle of between 30° and 60° (inclusive) to the first polarisation axis, more preferably at an angle of between 40° and 50° (inclusive) to the first polarisation axis, especially preferably at an angle of between 43° and 47° (inclusive), for example at an angle between 44° and 46° (inclusive), for instance, at an angle of substantially 45°.

The readhead could further comprise a diffractive (e.g. Fresnel lens) or refractive (e.g. cylinder/spherical) lens. It can be beneficial that the lens is located in the optical path between the polarised light source and the polarisation manipulator, such that the light from the light source hits/passes through the polarisation manipulator for the first time after it has passed through the lens. This can be to avoid adverse effects on the performance of the lens (e.g. reduced collimation, if the lens is a collimator).

There can be benefits to locating the polarisation manipulator in the optical path before the scale. In other words, it can be beneficial that the light from the polarised light source passes through the polarisation manipulator before it reaches/hits the scale. However, this need not necessarily be the case and the polarisation manipulator could be located in the optical path after the scale. As mentioned above and described in detail below, the polarisation manipulator could be located in the optical path before and after the scale (i.e. such that the light from the light source passes through the polarisation manipulator twice).

As mentioned above, the light from the polarised light source could pass through the polarisation manipulator twice in its path from the light source to the first sensor. For instance, the light from the polarised light source could pass through the polarisation manipulator a first time on its way to the scale and also a second (e.g. final) time after it has been reflected by the scale. This can be beneficial from the point of view in that it can be difficult to manufacture a position measurement encoder apparatus in which the light passes through the polarisation manipulator just once in its path from the light source to the first sensor. This is especially the case in those embodiments in which the apparatus also comprises other optical components, such the above mentioned diffractive (e.g. Fresnel lens) or refractive (e.g. cylinder/spherical) lens. In embodiments in which the light from the light source passes through the polarisation manipulator twice in its path from the light source to the first sensor, it can be beneficial that the polarisation manipulator/waveplate comprises an octadic (⅛) waveplate.

The scale's position features can be configured such they diffract the light into multiple diffraction orders. Advantageously, at least one of the diffraction orders can have a polarisation state, (e.g. (predominant) polarisation orientation) different to that of at least one other diffraction order. The apparatus could be configured such that, due to the first sensor being configured to sense light filtered along a first polarisation axis, the signal sensed by the first sensor is predominantly formed from a select subset of diffraction orders.

The apparatus could be configured such that the light sensed by the first sensor comprises a diffraction order composition that is different to that of the light sensed by the second sensor. This could be by way of: i) the polarisation state of the diffraction orders (e.g. different diffraction orders having different polarisation sates, e.g. different (predominant) polarisation orientations); ii) the first sensor being configured to sense light filtered along a first polarisation axis; and iii) the second sensor being configured to sense light filtered along a second polarisation axis.

Such an apparatus can provide improved performance over existing position measurement encoder apparatus. In particular, the signals sensed by the different sensors can be tailored as appropriate to provide an improved/optimised signal for each of the different sensors. For instance, whilst it might be beneficial to suppress the 0^{th} diffraction order from contributing to the signal sensed by the first sensor (e.g. which might be an incremental sensor), it might not be beneficial to do so for the second sensor (e.g. which might be a reference mark or absolute sensor). Accordingly, it is not desirable to completely block such diffraction orders from propagating toward the readhead's sensors, and so instead the present invention facilitates selective/bespoke suppression of diffraction orders for the readhead's different sensors, based on their polarisation state. For instance, the 0^{th} diffraction order can have a polarisation state that is different to the +/−1^{st} diffraction orders. For example, the 0^{th} diffraction order can have a (predominant) polarisation orientation that is substantially orthogonal to that of the +/−1^{st} diffraction orders.

The diffraction order composition can vary from one sensor to another in the sense that the extent to which the different diffraction orders contribute to/influence the signal as sensed by the sensors is different for the different sensors. For instance, the signal sensed by the first sensor and the signal sensed by the second could both be formed from the 0^{th} and +/−1^{st} diffraction orders, but, due to their polarisation states, the relative influences of the 0^{th} and +/−1^{st} diffraction orders on the formation of signal sensed by the first sensor is different to the relative influences of the 0^{th} and +/−1^{st} diffraction orders on the formation of signal sensed by the second sensor. For example, the apparatus could be configured such that the influence of the 0^{th} diffraction order on the signal sensed by the first sensor is 50% less than the influence of the 0^{th} diffraction order on the signal sensed by the second sensor.

Whilst it is possible to obtain some benefit from only partially attenuating the influence of a particular diffraction order (e.g. the 0^{th} diffraction order, or the +/−1^{st} diffraction orders) on the production of signal formed at a sensor, e.g. by attenuating the influence the particular diffraction order on the production of the signal by at least 50% as mentioned above, it is often preferable that the influence a particular diffraction order on the production of the signal sensed by a sensor is substantially fully attenuated, e.g. by at least 90%, for example by at least 95%, for instance by at least 98%. In particularly preferred embodiments, the readhead is configured such that one or more particular diffraction orders (e.g. the 0^{th} diffraction order, or the +/−1^{st} diffraction orders) has substantially no influence whatsoever on the production of the signal sensed by one of the first and second sensors, whilst its influence of the production of the signal sensed by the other sensor being left unaffected. Indeed, the invention has been found to provide most benefit when select diffraction orders are substantially completely suppressed for at least one of the sensors, whilst being left substantially unsuppressed for the other sensor.

Accordingly, the apparatus can be configured such that the signals sensed by the first and second sensors can be formed/composed from different subsets of the diffraction orders based on their polarisation state/orientation. For example, in one embodiment, the signal sensed by the first sensor can be formed from one or more diffraction orders other than the 0^{th} diffraction order (i.e. the 0^{th} diffraction order does not contribute to the signal sensed by the first sensor), whereas the 0^{th} diffraction order does contribute to the signal sensed by the second sensor (optionally along with other diffraction orders).

It is often the case in the field of encoder apparatus that the 0^{th} and the +/−1^{st} diffraction orders have the strongest influence on the signals formed at/sensed by the sensor(s). Accordingly, in preferred embodiments of the invention, the 0^{th} diffraction order has a different (e.g. orthogonal) (predominant) polarisation orientation to that of +/−1^{st} diffraction orders. This can enable selective control over the extent to which, or whether, the 0^{th} and/or +/−1^{st} diffraction orders influence or contribute to the signals sensed by the sensor(s). Although it can be possible to encode the +1^{st} diffraction orders to have a different polarisation state to the −1^{st} diffraction order, typically it is beneficial to configure the readhead such that they have the same polarisation state.

The scale's series position features could diffract light into multiple diffraction orders. The apparatus could be configured such that at least one diffraction order has a polarisation state different to that of at least one other diffraction order. The polarisation state of the diffraction orders can be imparted/encoded by the scale. Accordingly, the scale can comprise/be a diffraction order encoder. For instance, the scale could comprise a birefringent or hologram scale, such as that described in US Patent Application Publication US2003/0141441, which comprises a polarisation hologram recorded on the scale such that the polarisation orientation of the +/−1^{st} diffraction orders are rotated by 90° relative to the 0^{th} diffraction order.

Advantageously, the readhead can comprise a diffraction order encoder which encodes at least one diffraction order produced by the scale's series of position features with a polarisation state different to that of at least one other diffraction order produced by the scale's series of position features. Providing the readhead with a diffraction order encoder can be simpler and cheaper than providing a hologram scale. Further details of such a diffraction order encoder are provided below.

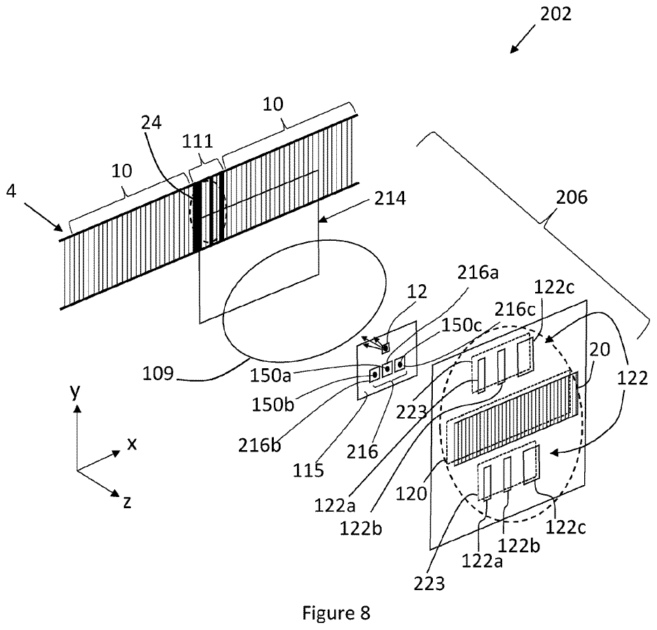

The polarisation manipulator could comprise, for instance, a “patterned retarder” (in other words, a “non-uniform retarder” or “structured retarder”). Accordingly, in contrast to the above-described embodiments, the polarisation manipulator can be configured such that the light output therefrom comprises a mix of polarisation orientations across its footprint/extent. In order to achieve this, the polarisation manipulator (e.g. an optical retarder element) can comprise a non-uniform fast axis, and/or a non-uniform retardance (or waveplate fraction), that varies along at least one axis/dimension. In other words, a polarisation manipulator (e.g. an optical retarder element) according to the present invention can comprise a fast axis, and/or a retardance, that is non-uniform along at least one axis/dimension. For instance, the polarisation manipulator can comprise a series of waveplate pixels, having different fast axes. As will be understood, the use of the terms “pattern” and “patterned” in this document, especially in connection with the polarisation manipulator, is not intended to imply that the presence of any sort of repeating configuration. Rather, the terms “pattern” and “patterned” are used to confer that the polarisation manipulator, e.g. the retarder, has a non-uniform design/form, in particular a non-uniform fast axis. As explained in more detail below, it is possible that the design/form/pattern of the (fast axis of the) polarisation manipulator (e.g. the retarder) does repeat, but it can be beneficial that it does not repeat. The patterned retarder could be configured such that there is a large variation in the angle of the fast axis along the least one axis/dimension. However, this does not necessarily have to be the case. For example, it has been found that, for a system in which light passes twice (e.g. as per the optical scheme of FIG. 8 or 14) through a patterned retarder having octadic (or ⅛) waveplate pixels, then it has been found beneficial for there to be a very small range of angles of the fast axes. For instance, it has been found beneficial that the fast axes of the waveplate pixels all have an angle such that they are angled at approximately 45°+/−1°.

The apparatus could be configured such that the sensor(s) (e.g. the first sensor and/or second sensor) is/are inherently at least partially blind to a particular polarisation state/orientation (and therefore inherently at least partially blind to one or more diffraction orders) (e.g. by way of an integrated polariser on the sensor having said first polarisation axis, the first sensor could be blind to light polarised that has a polarisation orientation orthogonal to the first polarisation axis). Accordingly, the composition of the signal as sensed by a sensor can be dictated by the extent to which the sensor is at least partially blind to the polarisation state/orientation. Optionally, the encoder apparatus comprises a first-sensor polarisation filter, configured to at least partially (e.g. substantially) filter light along said first polarisation axis based on its polarisation state/orientation before it falls on the first sensor. For instance, in those embodiments in which the readhead comprises a first sensor and a second sensor, the readhead can comprise a first-sensor polarisation filter (having said first polarisation axis) located before/in-front of the first sensor and/or a second-sensor polarisation filter (having said second polarisation axis) located before/in-front of the second sensor. Accordingly, the diffraction orders can be selectively at least partially (e.g. substantially) filtered out by the first-sensor filter and/or second-sensor filter based on their polarisation state/orientation. Therefore, the light that falls on the first sensor can be filtered differently to the light that falls on the second sensor. If a first-sensor filter and a second-sensor filter are both provided, they can be configured to at least partially (e.g. substantially) filter out different diffraction orders based on their polarisation states. Accordingly, the composition of the signal as sensed by the first and/or second sensor can be dictated/controlled by said filter(s).

The first sensor could be configured to sense light filtered along a first polarisation axis such that (substantially all) 0^{th} diffraction order light does not contribute to the signal sensed by and/or output by the first sensor. For example, the 0^{th} diffraction order could be prevented from reaching the first sensor (e.g. the 0^{th} diffraction order could be filtered out by a first-sensor polarisation filter). For instance, optionally the first-sensor polarisation filter prevents (substantially all) 0^{th} diffraction order light from reaching the first sensor (in other words, it substantially filters out the 0^{th} diffraction order).

Optionally, the second sensor is configured to sense light filtered along a second polarisation axis such that (substantially all)+/−1^{st} diffraction order light does not contribute to the signal sensed by and/or output by the second sensor. For example, the +/−1^{st} diffraction orders could be prevented from reaching the second sensor (e.g. the +/−1^{st} diffraction orders could be filtered out by a second-sensor polarisation filter). For instance, optionally the second-sensor filter polarisation prevents (substantially all)+/−1^{st} diffraction orders light from reaching the second sensor (in other words, it substantially filters out the +/−1^{st} diffraction orders).

As described in more detail below, diffraction orders greater than the +/−1^{st} diffraction order can be substantially suppressed/filtered out/prevented from contributing to the signals sensed by and/or output by (e.g. can be prevented from reaching) the first and/or second sensors. Accordingly, the signal formed at the first sensor could be formed predominantly (e.g. solely) from the +/−1^{st} diffraction orders. In other embodiments, the signal formed at the (e.g. second) sensor can be formed predominantly (e.g. solely) from the 0^{th} diffraction order.

The above-mentioned diffraction order encoder can comprise at least one polariser element configured to encode the at least one diffraction order with a polarisation state different to that of at least one other diffraction order. In particularly preferred embodiments, the diffraction order encoder comprises a first polariser element configured to encode the 0^{th} diffraction order with a first polarisation state (first predominant polarisation orientation), and one or more additional (e.g. second and third) polariser elements configured to encode the +/−1^{st} diffraction orders with a second polarisation state different (second predominant polarisation orientation) to the first polarisation state (orientation). Optionally, a polariser element comprises a polariser configured to polarise (e.g. increase the degree of polarisation of) at least one diffraction order. Optionally, a polariser element comprises at least one polarisation manipulator, e.g. a waveplate or retarder, configured to change the polarisation state of at least one diffraction order, e.g. configured to rotate the polarisation orientation of said at least one diffraction order.

In the embodiments in which the readhead comprises the diffraction order encoder, the polarised light source and the diffraction order encoder could be provided on a single mount member, in other words a single substrate, for instance a glass substrate.

The readhead can comprise at least one optical relay element for relaying light, e.g. said diffraction orders, from the scale toward the first and/or second sensors. For instance, the readhead can comprise at least one refractive and/or diffractive optical relay element. Suitable optical relay elements include a lens and/or a diffraction grating. The diffraction order encoder could be located to interact with the one or more diffraction orders before the optical relay element or after the optical relay element. Optionally, the diffraction order encoder and optical relay element could be one and the same thing (e.g. the at least one optical relay element could comprise the diffraction order encoder integrated within it).

Optionally, the apparatus is configured such that said diffraction orders converge to corresponding/respective spots (or “different points of convergence”) in the optical path before the first and/or second sensors. For instance, there can be a spot/point of convergence for each diffraction order, e.g. a 0^{th} diffraction order spot/point of convergence, a +1^{st} diffraction order spot/point of convergence, a −1^{st} diffraction order spot/point of convergence, and so on. Such spots could be located at a focal plane of the optical relay element for relaying the diffraction orders (focal plane of the lens). The diffraction order encoder can be located substantially at those points of convergence. For example, the diffraction order encoder can be located at the focal plane of the optical relay element, for example at the focal plane of the optical relay element. The spots could be formed at a conjugate plane of the light source. Accordingly, the spots could be images of the light source.

The polarisation states (e.g. (predominant) polarisation orientation) of diffraction orders greater than the +/−1^{st} diffraction orders can be configured such that the extent to which, or whether, they influence or contribute to the signal sensed by the first and/or second sensor can be selectively controlled. Such diffraction orders could include, for example the +/−3^{rd} diffraction orders and/or the +/−5^{th} diffraction orders. Optionally, the diffraction orders greater than the +/−1^{st} diffraction orders are simply prevented/stopped/blocked from reaching the first and/or second sensors such that they have no influence on the signal formed at the first and/or second sensors. Such diffraction orders could be stopped by way of absorption, deflection, scattering and/or reflection. For instance, opaque material can be located at said above-described spots/points of convergence for select or all diffraction orders greater +/−1^{st} diffraction orders than the at the conjugate plane of the light source so as to absorb and block such diffraction orders. Optionally, the diffraction order encoder is configured to encode diffraction orders greater +/−1^{st} diffraction orders with an polarisation state such that they do not interact/interfere with the 0^{th} and/or +/−1^{st} diffraction orders at the sensor (e.g. at the first and second sensors), or such that they are at least partially (e.g. substantially) filtered out, e.g. by an appropriate filter before they reach the sensor(s) (e.g. are filtered out by the first-sensor polarisation filter and/or second-sensor polarisation filter).

The scale could be illuminated with collimated light (and optionally the diffraction orders from the scale could themselves be collimated). Optionally, the readhead comprises an optical collimator element for collimating light from the polarised light source. Optionally, the same optical collimator element (for collimating light from the polarised light source) and the optical relay element for relaying the light (e.g. the diffraction orders) toward the first and/or second sensors are one and the same thing/optical element. Accordingly, optionally, the same optical element is used for collimating light from the polarised light source and for causing the diffraction orders to converge to corresponding/respective spots.

The apparatus can be configured such that the first and/or second sensors is/are located substantially at a conjugate plane of the scale. Accordingly, the position measurement encoder apparatus could be described as being an imaging encoder apparatus, wherein an image (or pseudo-image) of the scale is formed at the first and/or second sensors.

Preferably the scale comprises what is commonly referred to as an amplitude scale or “Ronchi” scale (c.f. a phase scale). As will be understood, in an amplitude or “Ronchi” scale, the features are configured to control the amplitude of light reflected (or transmitted in a transmission scale embodiment) toward the readhead (in particular towards the first and/or second sensors), e.g. by selectively absorbing, scattering and/or reflecting the light. In contrast a phase scale configured to control the phase of the light reflected (or transmitted in a transmission scale embodiment) toward the readhead (in particular towards its first and second sensor), e.g. by having scale features of different depths controlled to less than a fraction of the wavelength of the light. Typically, amplitude scale produces significant 0^{th} diffraction order along with significant+/−1^{st} diffraction orders (plus higher+/− odd diffraction orders of decreasing intensity), which is in contrast to phase scale which does not produce any 0^{th} diffraction order.

Optionally, the period of the scale is not more than 40 μm, preferably not more than 20 μm, for instance not more than 10 μm, for example not more than 8 μm.

Preferably, the scale comprises a feature-space (or “mark”-space) ratio of 1:1. Accordingly, in other words, the ratio of the width of the scale features to their spacing) of the scale is 1:1.

The scale could be a transmissive scale. Optionally, the scale is a reflective scale. Accordingly, optionally, the light source and the first and/or second sensor of the readhead are located on the same side of the scale.

Optionally, the position measurement encoder apparatus is a one-grating encoder system, wherein the scale comprises the only diffraction grating in the optical path between the light source and the first and second sensors.

The scale's series of position features could be provided in at least one track (a “scale track”). The scale could comprise one or more scale tracks.

The signal produced at the first sensor can comprise an incremental position signal, for instance an interference fringe pattern or modulated spots. Accordingly, the first sensor can comprise an incremental position sensor. The period of the fringe could be M.p/λ, where M is the magnification factor of the encoder's optical system, and p is the period of the scale (this is the case/can be achieved when the 0^{th} diffraction order has been substantially removed).

The scale can comprise an incremental scale track, comprising a series of periodic features defining an incremental scale track. One or more reference marks can be provided, embedded within, and/or located adjacent, the incremental scale track. Such a reference mark can comprise an optical reference mark.

Optionally, the signal produced at the first sensor comprises a reference mark signal. In those embodiments in which the readhead comprises first and second sensors, the second sensor can be configured to detect the reference mark signal produced by the reference mark.

Optionally, the signal produced at the first sensor comprises an absolute position signal. Accordingly, the first sensor can comprise an absolute position sensor. Accordingly, the scale can comprise an absolute scale track, comprising a series of features defining an absolute scale track. As will be understood, an absolute scale track differs to an incremental scale track (with or without reference marks) in that its features define a series of unique positions along the length of the scale which can be readhead by the readhead such the relative position of the readhead and scale can be determined (e.g. on start-up) at any position along the scale without requiring movement to a reference position (e.g. a reference mark). Examples of absolute scales include those described in US Patents U.S. Pat. Nos. 7,499,827 and 5,279,044.

The scale could comprise separate incremental and absolute scale tracks. Optionally, the incremental and absolute scale features are combined in one track. For instance, the absolute scale features could be superimposed on the periodic incremental scale features.

In those embodiments in which the readhead comprises first and second sensors the first sensor could be configured to detect an incremental scale/signal (and so could be referred to as an incremental sensor) and the second sensor could be configured to detect an absolute scale/signal (and so could be referred to as an absolute sensor), or vice versa.

Optionally, the scale comprises a first and a second series of position features which are readable by the readhead. The first series of position features can produce a first set of diffraction orders and the second series of position features can produce a second set of diffraction orders (which produce said signals detected by the first and second sensors). These first and second sets of diffraction orders can be superimposed on each other/spatially overlapping. The position measurement encoder apparatus could be configured such that only one of the first and second sets of diffraction orders has diffraction orders having different optical states. For example, the position encoder apparatus could be configured such that at least one diffraction order (e.g. the 0^{th} diffraction order) of the first set of diffraction orders has an optical state different to that of at least one other diffraction order (e.g. the +/−1^{st} diffraction order) of the first set of diffraction orders, but the diffraction orders (e.g. at least the 0^{th} and +/−1^{st} diffraction orders) of the second set of diffraction orders could have the same optical state. Alternatively, the position measurement encoder apparatus could be configured such that at least one diffraction order of the first set of diffraction orders has an optical state different to that of at least one other diffraction order, and such that at least one diffraction order of the second set of diffraction orders has an optical state different to that of at least one other diffraction order. Either way, as will be understood, the first and second sets of diffraction orders can be filtered differently based on their optical states.

The first and/or second series of position features can be periodic (in other words, the scale can comprise a first periodic series of position features and a second periodic series of position features). The period of the first series of position features can be different to the period of the second series of position features. For instance, the scale can comprise a scale track comprising a first series of position features having a first period (e.g. a relatively fine period) and a second series of position features having a second period (e.g. a relatively coarse period, i.e. coarser than the period of the first period). The first and/or second series of position features can be provided in the same track, i.e. embedded within each other/superimposed on each other.

As will be understood, the output of the first sensor (and the output of the second sensor if present) can provide one or more signals which can be used to indicate relative position information (concerning the readhead and scale). As explained in more detail later in this document, such position information can be incremental or absolute position information. Such position information can be an index (also known as a “reference”, or “datum”) position information. The position information could be linear position information or angular position information (e.g. in the case of a rotary encoder apparatus). The readhead could output the raw, unprocessed signal(s) from the sensor(s). Optionally, the readhead can process the signal(s) from the sensor(s) and output one or more signals derived from the signal(s) from the sensor(s). As is commonly the case with position encoders, the readhead can output one or more signals, for example quadrature signals (e.g. sin and cos signals) which change with a change in the relative position (i.e. which change with relative motion) of the scale and readhead. The readhead could output analogue or digital signals representative of the relative position of the scale and readhead. For instance, the quadrature signals could be analogue or digital quadrature signals. Optionally, the readhead can maintain and output an incremental “count” of the position of the readhead and scale (e.g. which could be counted from an index position). Optionally, the readhead can output digital codewords representative of the relative position of the scale and readhead. For example, the readhead can output absolute digital codewords representative of the absolute relative position of the scale and readhead. As will also be understood, a controller can use the output of the readhead to determine how to control the apparatus/device on which the encoder apparatus is installed.

The position measurement encoder apparatus could be a linear encoder apparatus or a rotary encoder apparatus. Accordingly, the scale could be a linear scale or a rotary scale (in which case the scale could be a ring scale or disc scale).

According to a second aspect of the invention there is provided a position measurement encoder apparatus comprising: a scale comprising a series of position features which are readable by a readhead; a readhead comprising: i) a polarised light source for emitting polarised light toward the scale; ii) a first sensor configured to sense light filtered along a first polarisation axis, the first sensor being arranged to sense light from the polarised light source that has interacted with the scale; iii) a waveplate, located in the optical path between the polarised light source and the first sensor, in which the effective total wave retardance of the waveplate is n+¼, where n is an integer ≥0, and which is arranged such that its fast axis is arranged at an angle of between 30° and 60° to the first polarisation axis.

The apparatus could comprise: iv) a second sensor configured to sense light filtered along a second polarisation axis that is orthogonal to the first polarisation axis, the second sensor being arranged to sense light from the polarised light source that has interacted with the scale.

The waveplate could comprise an octadic waveplate, and wherein the light from the light source passes through the octadic waveplate twice in its path from the light source to the first sensor (and second sensor if present).

The scale could diffract the light from the light source into multiple diffraction orders. The readhead could comprise a diffraction order encoder configured to: encode the 0^{th} diffraction order with a polarisation state that is aligned with the second polarisation axis, and encode the +/−1^{st} diffraction orders with a polarisation state that is aligned with the first polarisation axis. This could be such that the first sensor senses the +−/1^{st} diffraction orders but not the 0^{th} diffraction order and the such that the second sensor senses the 0^{th} diffraction order but not the +/−1^{st} diffraction orders.

Features described above in connection with the first aspect of the invention are equally applicable to this second aspect of the invention (and vice versa), but are not repeated here for the sake of brevity.

Embodiments of the invention will now be described, by way of example only, with reference to the following drawings, in which:

FIGS. 1a and 1b are schematic diagrams, illustrating the optical workings of a generic prior art position encoder system;

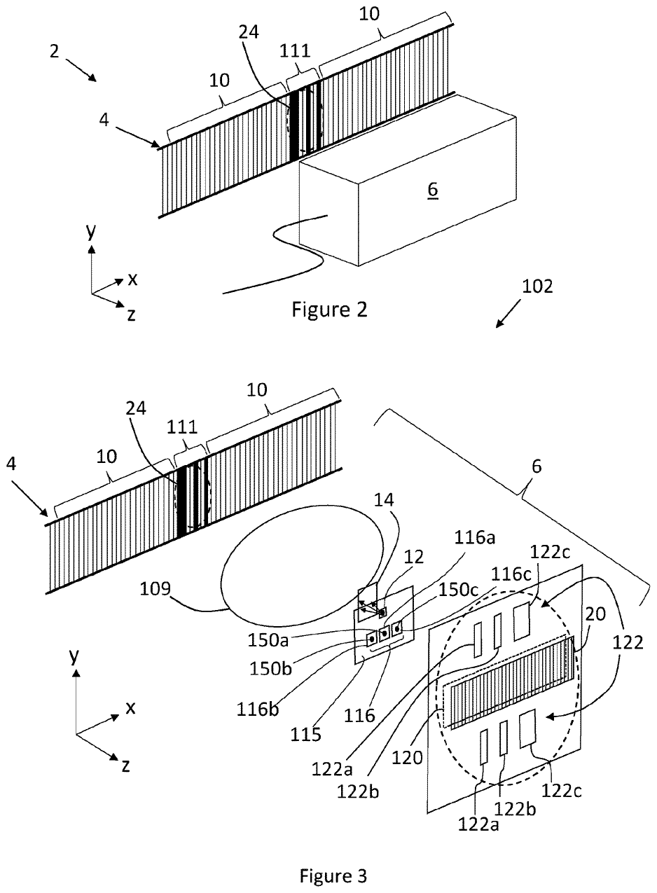

FIG. 2 illustrates an incremental scale and a readhead of an encoder apparatus according to the present invention;

FIG. 3 schematically illustrates the various optical components located within the readhead of FIG. 2 according to a first embodiment of the invention;

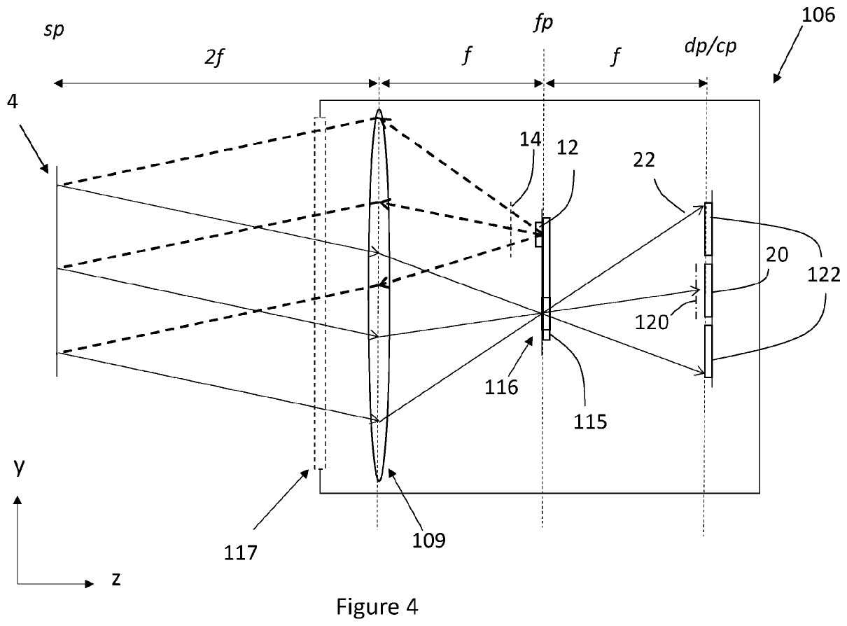

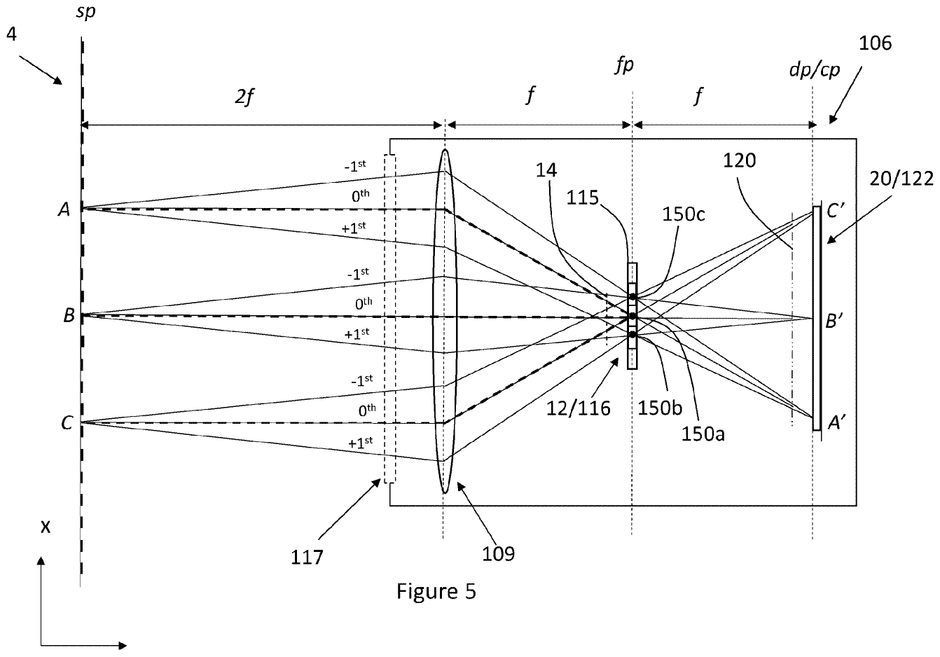

FIGS. 4 and 5 are schematic optical diagrams of the encoder apparatus of FIG. 3;

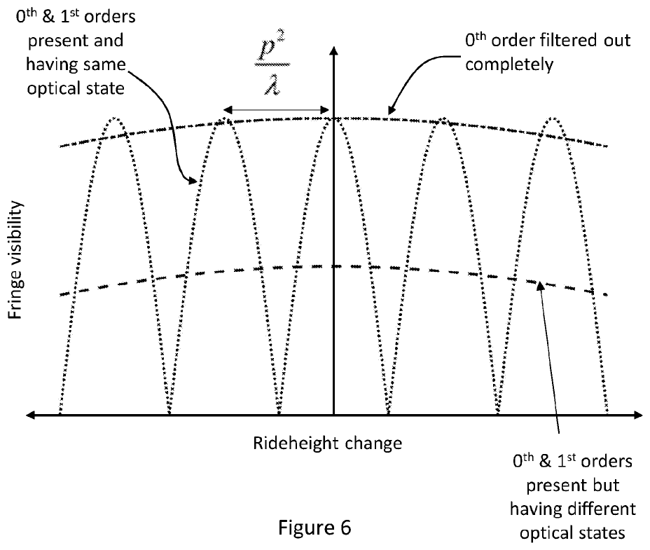

FIG. 6 is a graph illustrating the effect the 0^{th} order has on the visibility of the fringes falling on the sensor as the distance between the scale and the readhead changes;

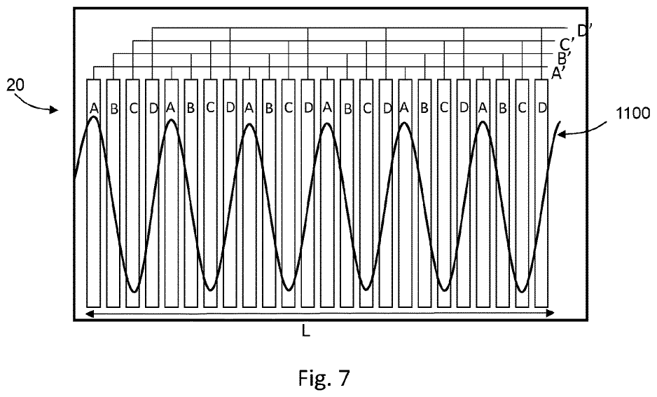

FIG. 7 illustrates an example electrograting sensor for use in the readhead of FIGS. 2 to 5;

FIG. 8 schematically illustrates an encoder apparatus according to a second embodiment of the invention;

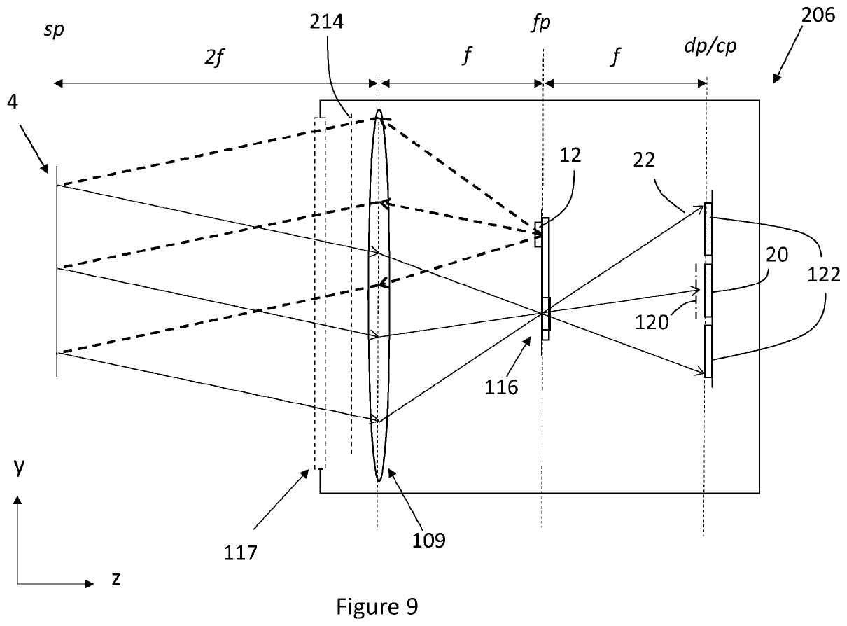

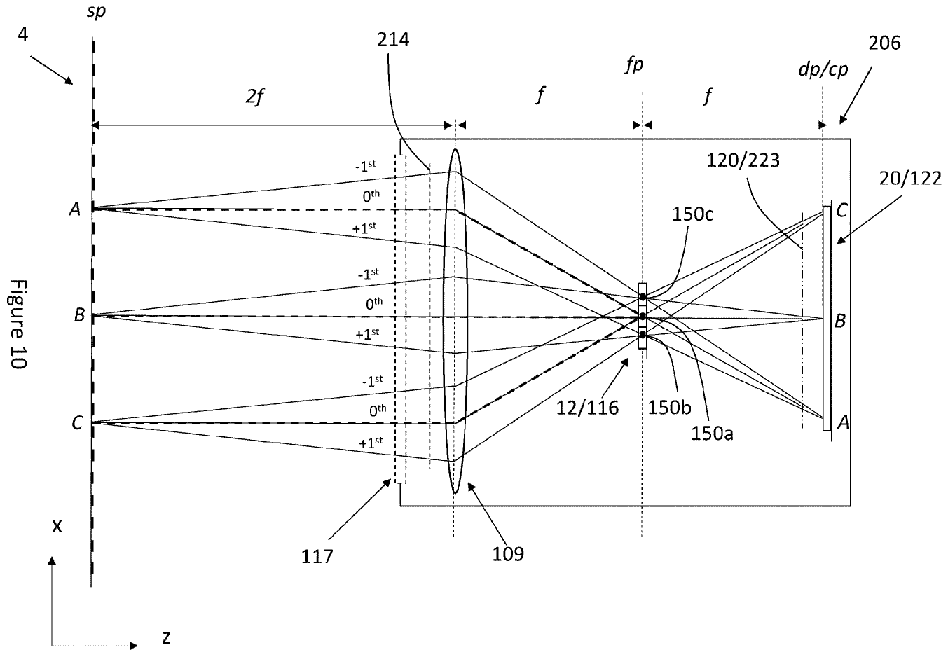

FIGS. 9 and 10 are schematic optical diagrams of the encoder apparatus of FIG. 8;

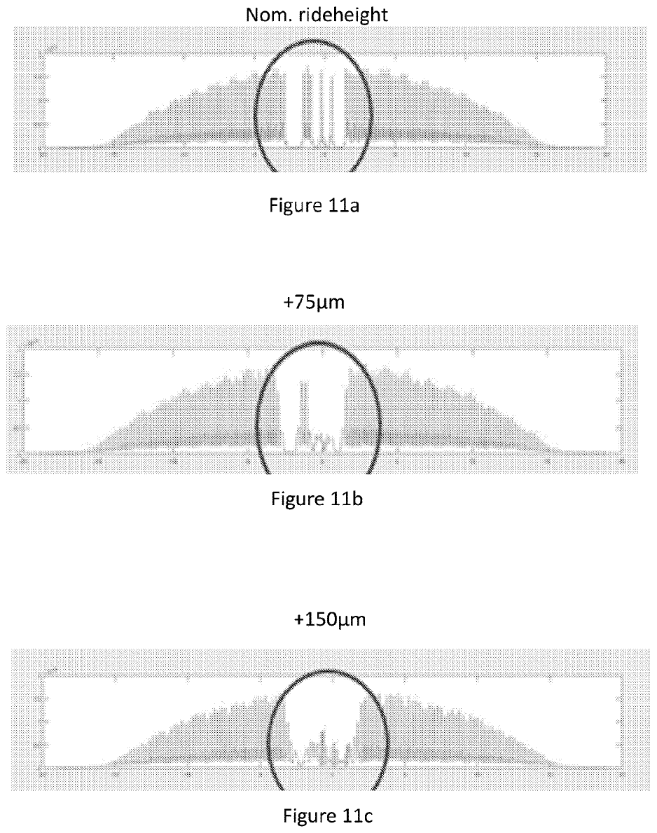

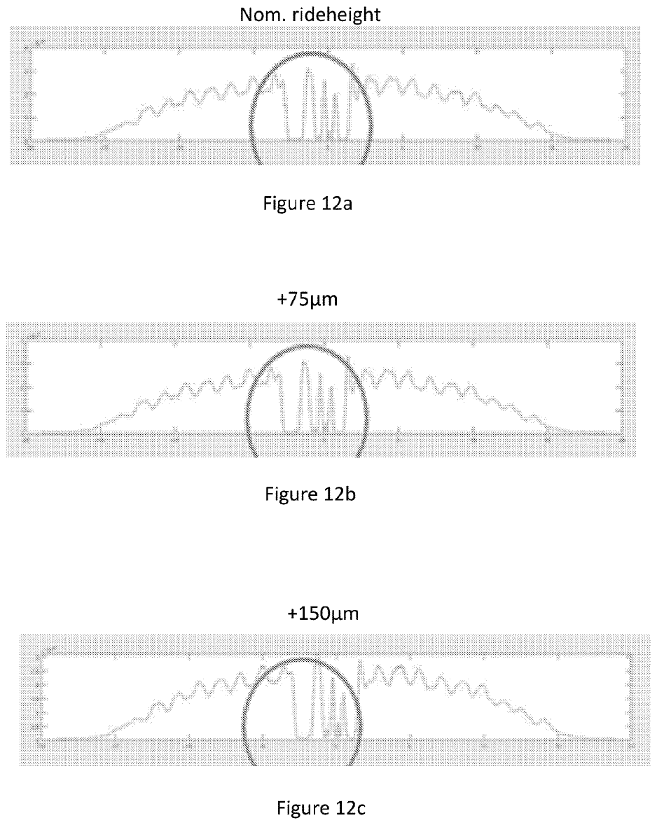

FIGS. 11 and 12 are graphs illustrating the effect of filtering out the +/−1^{st} diffraction orders on the image (or “pseudo-image”) at the readhead's detector plane;

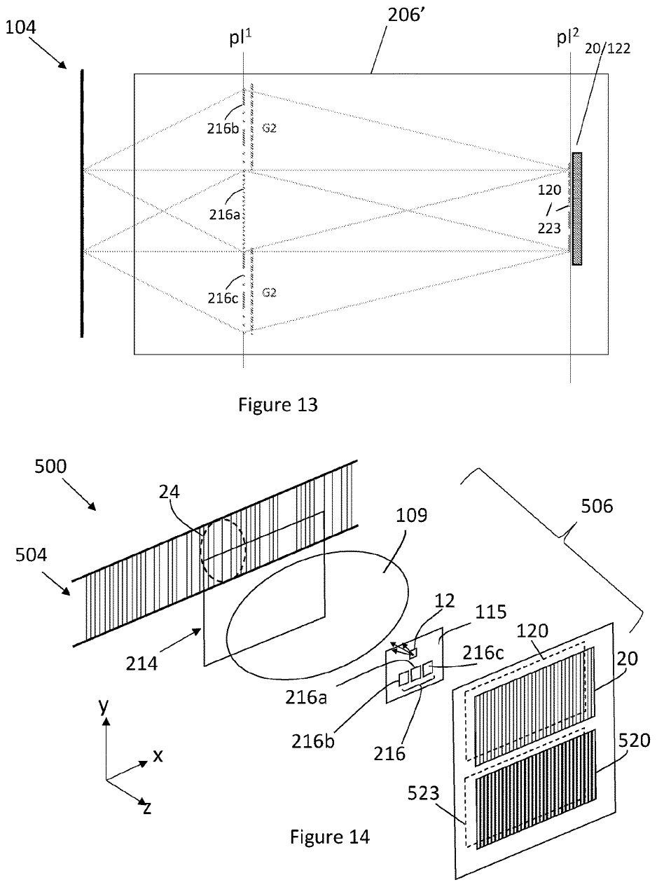

FIG. 13 schematically illustrates a schematic optical diagram of an encoder apparatus according to another embodiment of the present invention;

FIG. 14 schematically illustrates an absolute scale and readhead of an encoder apparatus according to another embodiment of the present invention;

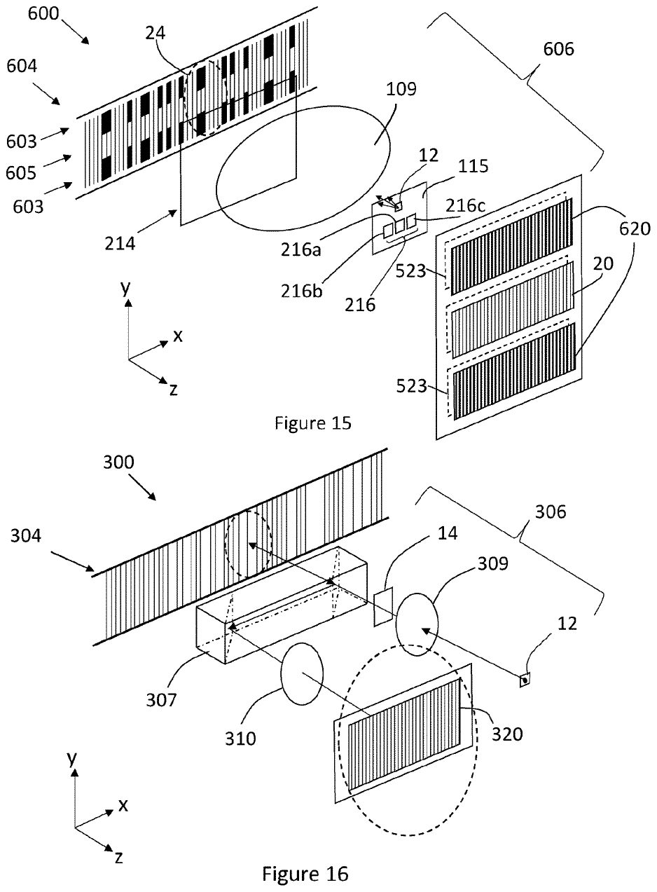

FIG. 15 schematically illustrates an absolute scale and readhead of an encoder apparatus according to another embodiment of the present invention;

FIG. 16 illustrates a scale and readhead of an encoder apparatus according to another embodiment of the present invention;

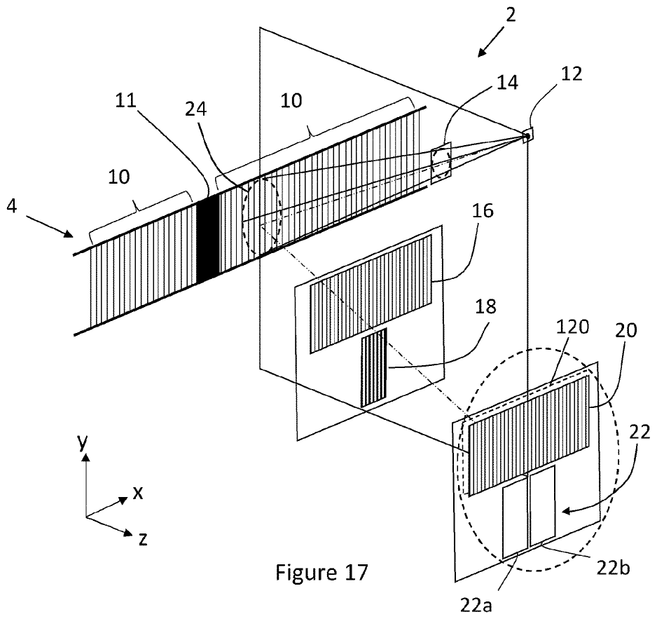

FIG. 17 schematically illustrates the various optical components of a readhead according to another embodiment of the invention;

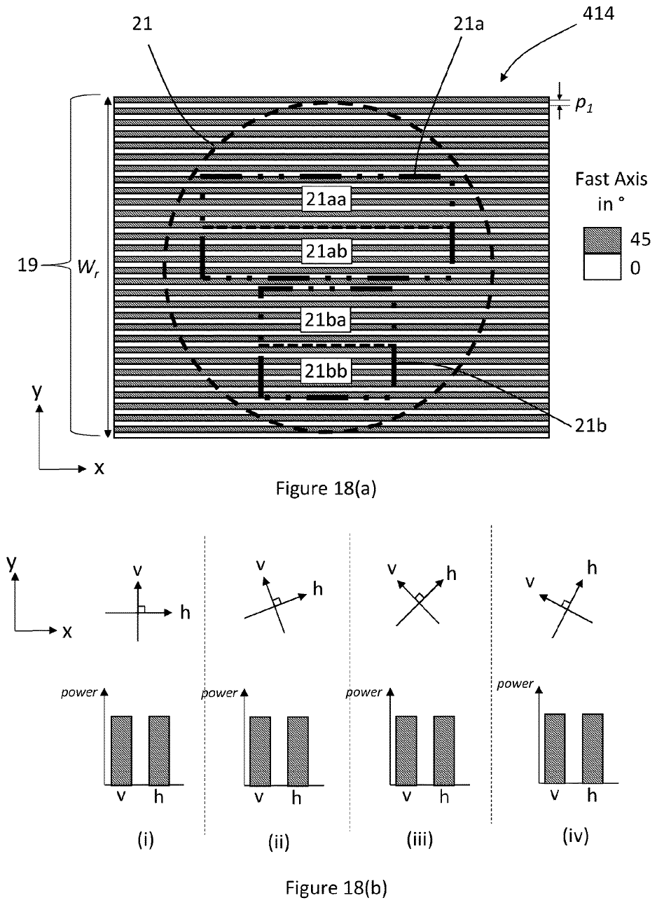

FIG. 18(a) illustrates an example polarisation manipulator for use in a readhead according to the present invention;

FIG. 18(b) shows four different (i-iv) example orientations of orthogonal polarisation axes (v, h) and a graph of the optical power along those orthogonal polarisation axes of the light output from the polarisation manipulator of FIG. 18(a) within the footprint of light; and

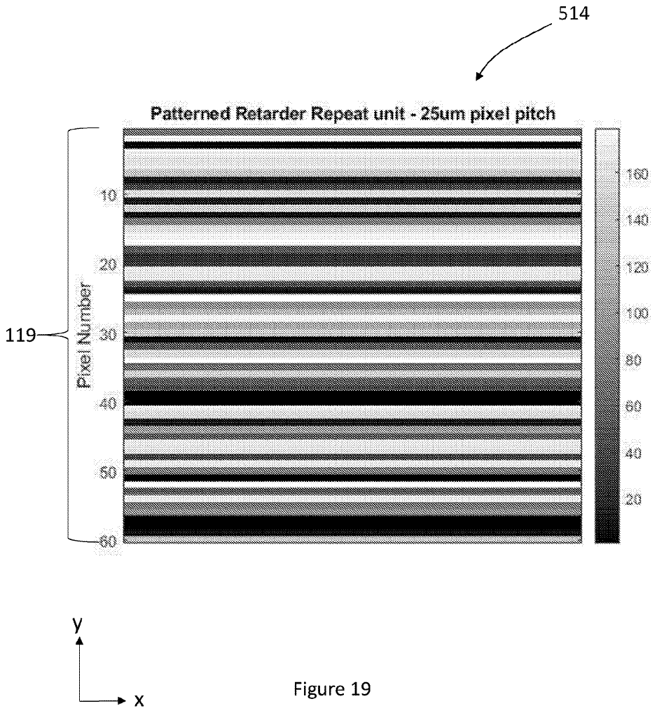

FIG. 19 illustrates an example polarisation manipulator for use in a readhead according to the present invention.

Referring to FIG. 2, an encoder apparatus 2 according to the present invention comprises a scale 4 and a readhead 6. The scale 4 and readhead 6 are moveable relative to each other in the X-dimension. For example, the scale 4 could be mounted to a stationary part of a machine (not shown) and the readhead 6 mounted to a moveable part of a machine (not shown) (although it could be the other way around, or indeed both could be moveable). The scale 4 could take many different forms, including for example linear scale as illustrated or rotary scale (e.g. provided on a ring wherein the scale features are provided on its circumferential edge, or on a disc wherein the scale features are provided on its planar face).

In the embodiment described, the scale 4 is an amplitude scale (in that it controls the amplitude of light leaving the scale toward the readhead) and comprises a substrate which has incremental features 10 in the form of periodic dark/relatively non-reflective lines made on an otherwise relatively reflective substrate such that between the incremental features 10 the scale is relatively reflective. Of course, the scale's incremental features 10 could be made in other ways, such as for example by forming relatively reflective lines on an otherwise relatively non-reflective substrate, or even by forming both the relatively reflective and non-reflective lines on a substrate. As will also be understood, the incremental features 10 could be provided in other ways, for example, the scale's incremental features 10 could be provided in the form of reflective facets or lines which reflect the light toward and away from the readhead. In the embodiment described, the scale's substrate is metal, although as will be understood other materials such as glass for instance could be used.

In an alternative embodiment, the scale 4 could be a phase scale, in which peaks and pits in the scale modulate the phase of light leaving the scale toward the readhead.

The incremental features 10 form the incremental scale facilitating measurement along the X axis (the “measurement dimension”). In the embodiment shown, a reference mark 111 is provided, and in particular is embedded within the incremental features 10. The reference mark 111 of this embodiment comprises a patterned reference mark, which in this embodiment comprises one thick dark band, and two thin dark bands, each separated along the measuring direction by at least one incremental feature between them. The term “patterned” in the expression “patterned reference mark” is not being used to imply that the reference mark has a repeating design/form, but rather is being used to confer that the reference mark has a non-uniform design/form. Of course, the “patterned reference mark” could have a repeating form/design, or may not have a repeating form/design. As will be understood, the reference mark need not necessarily be embedded within the incremental scale track. Instead, it could be provided in a separate track. In other embodiments, the reference mark is non-optical, or for instance not provided at all.

FIGS. 3 to 5 illustrate the various optical components located within the readhead 6 (for the sake of clarity, the body has been omitted, and the relative size and positions of the components are not to scale). In this embodiment, the readhead 6 comprises a polarised light source 12, a polarisation manipulator 14 (which as explained in more detail below in this embodiment is a ¼ (quarter) waveplate), a refractive lens 109, a diffraction order encoder 116, a primary position information sensor 20 (hereinafter referred to as the “incremental sensor” 20), a polarising filter 120 located in the optical path of the light heading toward the incremental sensor 20, and a secondary position information sensor 122 (hereinafter referred to as a “reference mark sensor” 122). In the embodiment described, the light source 12 and diffraction order encoder 116 are provided in substantially the same plane, on an opaque substrate 115. As will be understood, the substrate 115 does not actually need to be opaque, but being opaque means that the other diffraction orders are blocked which can be beneficial (described in more detail below).

The polarising filter 120 has a polarisation axis, and the polarising filter 120 will filter the light reaching the incremental sensor 20 along its polarisation axis. In the embodiment described, for ease of reference and explanation, the angle/orientation of the polarisation axis of the polarising filter will be described as being “horizontal”.

The ¼ (quarter) waveplate 14 has a fast axis, which is configured to be at an angle of 45° to the “horizontal” polarisation axis of the polarising filter 120 (the significance of which will be explained in more detail below). Unlike the embodiments of FIGS. 18 and 19, the ¼ waveplate 14 has a uniform fast axis (in that the angle/orientation of the fast axis is substantially the same, at least across the area through which light from the light source passes).

The polarised light source 12 emits polarised light, i.e. light having at least a predominant, if not sole, polarisation orientation. The polarised light source could emit linearly polarised light, or an elliptically polarised light. In this embodiment, the polarised light source 12 comprises a laser light source, in particular a VCSEL, which emits linearly polarised light, having a predominant polarisation orientation. As will be understood, the polarisation orientation and/or degree of polarisation (DOP) of light from a laser light source such as a VCSEL can vary unpredictably from one light source to another. Also, the polarisation orientation and/or the DOP of the light from a laser light source such as a VCSEL can change during the operation of the readhead 6, for example due to a change in operating environment such as a change in temperature and applied current (which could change due to servoing). Typically, the DOP of the type of VCSEL used in the embodiment described will be in the region of 0.3 to 0.7. As will be understood, the light source could inherently emit polarised light, such as the VCSEL 12, or could comprise an unpolarised light emitter and an associated polariser which polarises light emitted from the unpolarised light emitter.

In the embodiment described, light from the VCSEL 12 is emitted toward the scale 4 through the ¼ waveplate 14 (the significance of which will be explained in more detail below). The light output from the ¼ waveplate 14 is relayed to the scale 4 via the lens 109 (through a clear/transparent window 117 in the readhead 106). The VCSEL 12 is positioned at the focal length f of the lens 109, such that light from the VCSEL 12 is collimated by the lens 109 as it hits the scale 4. The light from the VCSEL 12 illuminates a footprint 24 on the scale 4. Light travelling toward the scale is schematically illustrated by bold dashed rays in FIGS. 4 and 5, whereas light returning from/reflected by the scale is illustrated by thin solid rays.

The lens 109 relays light reflected by the scale 4 to the incremental 20 and reference mark 122 sensors.

As will be understood, owing to the well-known natural phenomenon of diffraction, light reflected by the scale 4 will be diffracted due to the presence of the scale features thereon (i.e. in the same way as that described above in connection with FIGS. 1a, 1b). In the case of the incremental features 10, which are periodic, the light reflected thereby will be diffracted into identifiable diffraction orders. As explained above in connection with FIGS. 1a and 1b, the light will be diffracted in the X-dimension into 0^{th} and +/−1^{st} diffraction orders. Higher diffraction orders (e.g. +/−3^{rd} and +/−5^{th}) will also be present, but these are not illustrated because they have a substantially lower intensity than the 0^{th} and +/−1^{st} diffraction orders, and in any case, in the embodiment described, they are blocked from progressing to either the incremental 20 or reference mark 122 sensors by the opaque substrate 115.

The diffracted orders are incident on the lens 109, which causes corresponding diffraction orders to converge so as to form spots 150 at the back focal plane fp of the lens 109; each spot being formed from a respective diffraction order. The spots 150 are images of the light source, in that the back focal plane fp is the conjugate plane of the plane at which the light source is located.

In this embodiment, the diffraction order encoder 116 is co-located with the spots 150. In particular, in this embodiment, the diffraction order encoder 116 comprises a 0^{th} order polariser 116a (e.g. having a “vertical” polarisation axis) which coincides with the 0^{th} diffraction order spot 150a, and first 116b and second 116c non-polarised transparent regions which coincide with the +/−1^{st} diffraction order spots 150b, 150c. Accordingly, the diffraction order encoder 116 encodes the 0^{th} diffraction order with vertically polarised light only, whilst leaving the polarisation of the +/−1^{st} diffraction orders unaffected.

The 0^{th} and +/−1^{st} diffraction orders propagate toward the incremental 20 and reference mark 122 sensors. As mentioned above, the polarisation filter 120 has a “horizontal” polarisation axis, and therefore has a polarisation axis that is orthogonal to the polarisation axis of the 0^{th} order polariser 116a. Accordingly, 0^{th} order diffracted light is blocked from reaching the incremental sensor 20. In contrast, +/−1^{st} order diffracted light can pass through the polarisation filter 120 (albeit becoming “horizontally” polarised in the process), and thereby fall on the incremental sensor 20. In particular, the +/−1^{st} diffraction orders propagate toward the incremental sensor 20, and interact (constructively and destructively interfere) to form an interference fringe pattern (or “fringe field”) which falls on the incremental sensor 20. Movement of the readhead 6 relative to the scale 4 causes movement of the interference fringe pattern relative to the incremental sensor 20 thus enabling an up/down count to be made by downstream electronics, which thereby enables a measurement of relative displacement.

Blocking the 0^{th} diffraction order provides a number of improvements to the interference fringe pattern which falls on the incremental sensor 20. In particular, the interference fringe pattern visibility is improved. Also, removal of the 0^{th} diffraction order means that the interference fringe pattern produced at the incremental sensor 20 has a period equal to M.p/λ(which is half of the system which does not block the 0^{th} diffraction order). Accordingly, blocking the 0^{th} diffraction order effectively doubles the system resolution.

FIG. 6 illustrates another advantage of removing the 0^{th} diffraction order. In particular, FIG. 6 shows the effect blocking the 0^{th} diffraction order has on the visibility of the fringes falling on the incremental sensor 20 as the distance (commonly known as the “rideheight”) between the scale 4 and the readhead 106 changes. As shown, when the 0^{th} diffraction order contributes fully to the fringe field, the visibility of the fringe field is modulated with a period of p²/λ, where p is the scale period and λ is the Wavelength of the light. If the 0^{th} order is eliminated, the modulation is no longer present. This is beneficial because it allows an encoder apparatus with a scale which produces a 0^{th} diffraction order to have a rideheight tolerance which is independent of the scale period.

Accordingly, in summary, blocking the 0^{th} diffraction order produced by the scale improves the absolute fringe visibility of the fringe field falling on the incremental sensor 20, effectively doubles the system resolution, and significantly improves the rideheight tolerance of the readhead.

Furthermore, if the diffraction orders >1^{st} are also blocked (as is the case in this embodiment due to the opaque substrate 115), then higher order harmonics are removed from the fringe field, providing a purer interference fringe pattern. As will be understood, in an alternative embodiment, blocking the diffraction orders >1^{st} is not necessary, and for instance, the substrate 115 could be transparent (in which case the first 116b and second 116c non-polarised transparent regions might not be distinctly identifiable).

In the embodiment described above, there is no polarisation filter in front of the reference mark sensor 122. Accordingly, the 0^{th} and the +/−1^{st} diffraction orders all fall on the reference mark sensor 122. Depending on various factors (which will be described in more detail below) it could in some circumstances be favourable to not place a polarisation filter in front of the reference mark sensor. Indeed, if the presence of both the 0^{th} and the +/−1^{st} diffraction orders falling on the reference mark sensor have no detrimental effect on the optical signal, e.g. “image” or “pseudo-image” (see later), formed at the reference mark sensor 122, then there is no advantage to providing a corresponding filter in front of the reference mark sensor 122 (and indeed, doing so could be detrimental owing to reduced photometry).

Accordingly, as explained above, the signal sensed by the incremental sensor 20 is formed from only +/−1^{st} diffraction orders, whereas the signal sensed by the reference mark sensor 122 is formed from the 0^{th} and +/−1^{st} diffraction orders. Accordingly, the signal sensed by the incremental sensor 20 is formed from a diffraction order composition that is different to that of the signal sensed by the reference mark sensor 122.

One thing to note is that in this embodiment the 0^{th} order and the +/−1^{st} diffraction orders are unevenly attenuated due to the 0^{th} order having been polarised by the 0^{th} order polariser 116a. If desired, uneven attenuation could be avoided/reduced by replacing the first 116b and second 116c non-polarised transparent regions with polarising filters which have a “horizontal” polarisation axis (i.e. having a polarisation axis that is orthogonal to the polarisation axis of the 0^{th} order polariser 116a). In such an embodiment, the 0^{th} and the +/−1^{st} diffraction orders falling on the reference mark sensor 122 will have been attenuated, which could result in a better quality image falling on the reference mark sensor. Furthermore, the +/−1^{st} diffraction orders will still pass through the polarisation filter 120 and interfere to form an interference fringe pattern on the incremental sensor 20. Either way, as will be understood, the light falling on the incremental sensor 20 has been filtered differently to the light falling on the reference mark 122 sensor.

The light falling on the incremental 20 and reference mark 122 sensors could be described as being an “image” of the scale 4, in that the incremental 20 and reference mark 122 sensors are positioned at a detector plane dp which, in the embodiment shown and described, is coplanar with the conjugate plane cp of the scale plane sp (such that, for example, light from point A on the scale is imaged to point A′ on the sensor, light from point B on the scale is imaged to point B′ on the sensor, and light from point C on the scale is imaged to point C′ on the sensor). However, as will be understood, the suppression/blocking of selective diffraction orders such that they do not reach the sensors will have an effect on the “image” as seen at the conjugate plane cp. For example, removal of the 0^{th} diffraction order (and diffraction orders greater than the 1^{st} diffraction order due to the opaque substrate 115 blocking them) means that the “image” at the conjugate plane cp as falling on the incremental sensor 20 has a purer sinusoidal waveform rather than a square-shaped waveform, and so the image on the sensor is not actually a “true” or “perfect” image of the scale 4 (but rather could be referred to as a pseudo-image of the scale). As will be understood, owing to the presence of the 0^{th} order at the reference mark sensor 122, the “image” of the scale 4 at the reference mark sensor 122 is affected to a lesser extent, especially when both the 0^{th} and +/−1^{st} diffraction orders have been polarised by the diffraction order encoder 116 such that they fall on the reference mark sensor 122 with equal measure.

Without the ¼ waveplate 14, what falls on the incremental sensor 20 and reference mark sensor 122 will vary depending on the predominant polarisation state/orientation emitted by the VCSEL 12. At worst it could mean that the incremental sensor 20 sees no light at all. For instance, in a set up identical to that of FIG. 3 but without the ¼ waveplate, the incremental sensor 20 would see no light at all if the VCSEL light source 12 emits only vertically polarised light. However, it can be assured that the incremental sensor 20 will receive a decent signal regardless of the polarisation orientation of the VCSEL light source 12, by providing a ¼ waveplate 14 in the optical path between the light source 12 and incremental sensor 20, and configuring it such that its fast axis and the polarisation axis of the polarising filter 120 of the incremental sensor 20 are angled with respect to each other. For example, arranging the fast axis of the ¼ waveplate 14 to be at 45° to the polarisation axis of the incremental sensor's polarisation filter 120 means that, for all other factors being equal (e.g. for a constant optical power output from the VCSEL 12), the optical power of the signal falling on the incremental sensor 20 will be the same regardless of the polarisation state of the light output by the VCSEL 12. Another way of looking at this, is that, of the light leaving the ¼ waveplate 14 toward the incremental sensor (which in this embodiment will be via the lens 109, scale 4, lens 190 again, diffraction order encode 116 and the polarisation filter 120) the ratio of: i) the optical power of light resolvable along the “horizontal” polarisation axis of the polarising filter 120, to ii) the optical power of light resolvable along an orthogonal “vertical” axis, is 1:1. This will be true regardless of the polarisation state of the light output by the VCSEL 12 (because of the 45° angle between the ¼ waveplate's fast axis and the polarisation axis of the polarising filter 120 of the incremental sensor 20).

As will be understood, whilst it can be preferred that the angle between the ¼ waveplate's fast axis and the polarisation axis of the polarising filter 120 of the incremental sensor 20 is 45° (so as to ensure that, for all other factors being equal, the optical power of the signal falling on the incremental sensor 20 is the same regardless of the polarisation state of the light output by the VCSEL 12), this is not essential. As will be understood, deviation of the angle between the ¼ waveplate's fast axis and the polarisation axis of the polarising filter 120 of the incremental sensor 20 away from 45° will mean that the optical power of the signal falling on the incremental sensor 20 will not be the same regardless of the polarisation state of the light output by the VCSEL 12. Nevertheless, it could be acceptable that the optical power of the signal falling on the incremental sensor 20 varies depending on the polarisation state of the light output by the VCSEL 12. In such a case, the limits of the acceptable angles between the ¼ waveplate's fast axis and the polarisation axis of the polarising filter 120 of the incremental sensor will be dependent on the acceptable extent of variation in the optical power of the signal falling on the incremental sensor 20. Nevertheless, the inventors have found that, in general, it is desired that the angle between the ¼ waveplate's fast axis and the polarisation axis of the polarising filter 120 of the incremental sensor is between 30° and 60°, more preferably between 35° and 55°, especially preferably between 40° and 50°.

In the embodiment described, the incremental sensor 20 is in the form of an electrograting, which in other words is a photo-sensor array which comprises two or more sets of interdigitated/interlaced/interleaved photo-sensitive sensor elements (also referred to herein as “photodetectors” or “fingers”). Each set can, for example, detect a different phase of a fringe pattern/field (schematically represented by wave 1100) at the incremental sensor 20. An example of an electrograting is illustrated in FIG. 7, in which a part of an electrograting is shown, and in which the fingers/photodiodes of four sets of photodiodes (A, B, C and D) are interdigitated/interleaved to form an array of sensor elements extending along the length “L” of the sensor.

The output from each finger/photodiode in a set is combined to provide a single output, thereby resulting in four channel outputs: A′, B′, C′ and D′. These outputs are then used to obtain the quadrature signals SIN and COS. In particular, A′-C′ is used to provide a first signal (SIN) and B′-D′ is used to provide a second signal (COS) which is 90 degrees out of phase from the first signal. Although in the specific embodiment the electrograting comprises four sets of photodiodes providing four the channels A′, B′, C′ and D′, this need not necessarily be the case. For example, the electrograting could comprise two sets of photodiodes providing just two channels A′ and B′.

As will be understood, other types of sensor could be used instead of the above described electrograting. For example, in embodiments in which modulated spots are created by the readhead's optical system instead of an interference fringe pattern, bulk sensor photodiodes could be used to detect the intensity of the modulated spots (e.g. as described in U.S. Pat. No. 4,776,701). Similar to a system which produces a fringe pattern, in a system which produces modulated spots, encoding the 0^{th} and +/−1^{st} diffraction orders such that they do not interfere with each other at the sensor effectively doubles the resolution of the encoder system (in that the intensity of the spots modulate with a frequency of p/λ). Similarly, encoding the diffraction orders higher than the +/−1^{st} diffraction orders with an optical state different to the +/−1^{st} diffraction orders reduces/removes, harmonics on the modulated spot intensity.

In the embodiment described, the reference mark sensor 122 comprises two sets of correspondingly arranged and shaped/sized photodiodes 122a, 122b, 122c, located on opposing sides of the incremental sensor 20. Each of the sets of photodiodes 122a, 122b, 122c of the reference mark sensor 122 are configured such that, when, and only when, the readhead 6 and reference mark 111 are aligned, an image (or “pseudo-image”—explained above) of the reference mark 111 pattern falls on, and lines up/correlates with the pattern of the, three photodiodes 122a, 122b, 122c of the reference mark sensor 122, thereby causing a significant and sharp change in intensity of light falling thereon. In this embodiment, wherein the reference mark 111 comprises dark bands, there will be a significant drop in the intensity of light received at the reference mark sensor 122 when the readhead 6 and reference mark 111 are aligned. Signal processing electronics and/or software downstream of the reference mark sensor 122 can be configured to identify such a change in intensity of light received at the reference mark sensor 122 and output a signal indicating the presence of the reference mark. As far as the downstream signal processing electronics and/or software is concerned, the two sets of correspondingly arranged photodiodes 122a, 122b, 122c act as one photodiode.

An alternative embodiment of an encoder apparatus 202 according to the present invention is shown in FIGS. 8, 9 and 10. This embodiment shares some parts which are identical to the embodiment of FIGS. 3 to 7 and like parts share the same reference numeral.

In the present embodiment, the polarisation manipulator 214 differs to that of the previous embodiment. For a start, in the present embodiment the polarisation manipulator 214 is located in the optical path between the lens 109 and the scale 4 (i.e. between the lens 109 and the window 117 of the readhead 206). The inventors found that it can be beneficial to provide the polarisation manipulator 214 after the lens 109. For instance, after collimation, all incident angles are the same, and can mean that the polarisation manipulator 214 has better performance. Also, the polarisation manipulator 214 may have optical aberrations which might impede the collimation. Furthermore, locating the polarisation manipulator here can be easier from a manufacturing point of view.

As illustrated in FIGS. 9 and 10, in contrast to the embodiment of FIGS. 3 to 7, the light from the VCSEL 12 passes through the polarisation manipulator 214 twice; once on its way toward the scale 4 and once on its return from the scale 4 toward the sensors (20, 122). In reality, the extent of overlap at the polarisation manipulator 214 of the beams of light toward and from the scale 4 will likely be greater than that schematically shown in FIG. 9.

In this embodiment, the polarisation manipulator 214 comprises an octadic (i.e. “⅛”) waveplate rather than the ¼ waveplate of the single-pass embodiment of FIGS. 3 to 7. Nevertheless, as will be understood, due to the double-pass of light through the octadic waveplate 214, (and as per the embodiment of FIG. 3) the effective total retardance of the polarisation manipulator 214 is n+¼ of the wavelength of the light emitted by the light source 12, where n is an integer ≥0 (in the embodiment described, n=0). As per the embodiment of FIGS. 3 to 7, the fast axis of the octadic waveplate 214 is arranged at an angle of 45° to the polarisation axis of the first polarising filter 120 (and in this embodiment will therefore also be at an angle of 45° to the polarisation axis of the second polarising filter 223—described in more detail below). Also as per the embodiment of FIGS. 3 to 7, whilst it can be preferred that the fast axis of the octadic waveplate is arranged at an angle of 45° to the polarisation axis of the first polarising filter 120, this is not essential.

The diffraction order encoder 216 of the present embodiment differs to that of the embodiment of FIGS. 3 to 7. In the present embodiment, the diffraction order encoder 216 comprises a 0^{th} order polariser 216a coincident with the 0^{th} diffraction order spot 150a, a +1^{st} order polariser 216b coincident with the +1^{st} diffraction order spot 150b, and a −1^{st} order polariser 216c coincident with the −1^{st} diffraction order spot 150c. The polarisation axis of the +1^{st} order 216b polarising filter and the polarisation axis of the −1^{st} order 216c polarising filter, are configured with the same orientation as each other, such that the +/−1^{st} diffraction orders are polarised by the +1^{st} order 216b and −1^{st} order 216c polarising filters such that they have the same (e.g. “horizontal”) polarisation orientation as each other. The polarisation axis of the 0^{th} order polariser 216a is configured with a different, and preferably orthogonal, orientation to the polarisation axis of the +1^{st} order 216b and −1^{st} order 216c polarising filters, such that the 0^{th} diffraction order is polarised with a different (e.g. “vertical”) polarisation orientation to the +/−1^{st} diffraction orders. Accordingly, the diffraction order encoder 216 encodes the +1^{st} and −1^{st} diffraction orders with a first polarisation orientation, and encodes the 0^{th} diffraction order with a second polarisation orientation that is different to the first polarisation orientation. As shown, the 0^{th} order polariser 216a, +1^{st} order polariser 216b, and −1^{st} order polariser 216c are spaced apart from each other such that they do not directly touch each other, but this need not necessarily be the case.

The polarised diffraction orders propagate toward the incremental 20 and reference mark 122 sensors. In the same way as the embodiment described above in connection with the embodiment of FIGS. 3 to 7, a first polarising filter 120 is located in the optical path of the diffraction orders heading toward the incremental sensor 20. The first polarising filter 120 has a polarisation axis which is parallel to that of the +1^{st} order polariser 216b and −1^{st} order polarising 216c (and therefore is orthogonal to the polarisation axis of the 0^{th} order polariser 216a). Accordingly, 0^{th} order diffracted light is blocked from reaching the incremental sensor 20. In contrast, +/−1^{st} order diffracted light can pass through the first polarising filter 120, and thereby fall on the incremental sensor 20. In particular, the +/−1^{st} diffraction orders propagate toward the incremental sensor 20, and interact (constructively and destructively interfere) to form a fringe field which falls on the incremental sensor 20. The benefits of preventing the 0^{th} diffraction order from contributing to the optical signal falling on the incremental sensor 20 was described above in connection with the embodiment of FIGS. 3 to 7.

In contrast to the embodiment of FIGS. 3 to 7, a second polarising filter 223 is located in the optical path of the diffraction orders heading toward the reference mark sensor 122. In particular, the secondary-sensor filter 223 comprises a polarising filter, having a polarisation axis that is parallel to the polarisation axis of the 0^{th} order polariser 216a (and therefore is orthogonal to the polarisation axis of the +1^{st} polarising filter 216b and −1^{st} polarising filter 216c). Accordingly, the second polarising filter 223 will block the +/−1^{st} diffraction orders and thereby prevent them from contributing to the optical signal falling on the reference mark sensor 122. Therefore, only the 0^{th} diffraction order light will reach, and contribute to the optical signal falling on, the reference mark sensor 122. Such an arrangement has been found to be advantageous, in particular in those embodiments where there are incremental features located within the reference mark.

For example, referring to FIGS. 11 and 12, the effect of filtering out the +/−1^{st} diffraction orders on the image (or “pseudo-image”) at the readhead's detector plane dp is illustrated. In particular, FIGS. 11a, 11b and 11c respectively illustrate the image of the scale that will be reconstructed at the readhead's detector plane dp/conjugate plane cp from both the 0^{th} and +/−1^{st} diffraction orders when the readhead is located at: a) the readhead's nominal rideheight; b)+75 μm from the nominal rideheight; and c)+150 μm from the nominal rideheight. As illustrated, at the nominal rideheight, the image of the reference mark (highlighted by the circle in FIGS. 11a to 11c) is good, but the image of the reference mark is substantially corrupted when the readhead moves away from its nominal rideheight. This has been found to be a particular problem when the reference mark contains periodic incremental features, but can be a (albeit smaller) problem even for reference marks which do not comprise incremental features. Such corruption of the image causes the signal output by the reference mark sensor 122 to be broader and less distinct as the readhead passes the reference mark, which can cause problems with the reliability of the reference mark (e.g. the signal is so weak that the reference mark is not detected) and/or the repeatability of the reference mark (e.g. the reference mark signal is so broad that it is not repeatable to within one incremental period.

FIGS. 12a, 12b and 12c respectively illustrate the image of the scale that is reconstructed at the readhead's detector plane dp/conjugate plane cp from just the 0^{th} diffraction order when the readhead is located at: a) the readhead's nominal rideheight; b)+75 μm from the nominal rideheight; and c)+150 μm from the nominal rideheight. As illustrated by FIG. 12, the image of the reference mark (highlighted by the circle in FIGS. 12a to 12c) reconstructed at the readhead's detector plane dp/conjugate plane cp maintains good structure and maintains a good likeness of the reference mark, and in turn provides for a distinct, strong reference mark signal from the reference mark sensor 122, even at rideheights away from the nominal rideheight. Accordingly, it has been found beneficial to provide a secondary-sensory filter 223 in front of the reference mark sensor 122 which filters out the +/−1^{st} diffraction order such that they do not contribute to the image of the scale reconstructed at the readhead's detector plane dp/conjugate plane cp. In particular, such a configuration provides a readhead with better rideheight tolerance.

As will be understood, other reference mark sensor arrangements could be used. For instance, the reference mark sensor 122 could comprise a split detector, wherein the photodiodes 122a, 122b, 122c are duplicated and laterally offset in the X-dimension, and the outputs from the duplicated photodiodes being connected to form the second reference mark output which can be used to provide a difference signal, (e.g. as described in WO2005/124282). Also, for example, the reference mark sensor 122 does not need to comprise sensing elements on either side of the incremental sensor. Furthermore, for instance, one or more of the reference mark sensing elements could be partially or fully embedded within the incremental sensor (e.g. as described in WO2005/124282).

As an alternative embodiment, the first polarising filter 120 could be omitted such that only the reference mark sensor 122 has a polarising filter in front of it (thereby obtaining the above-described benefits of filtering out select diffraction orders such that they don't reach the reference mark sensor 122).

Accordingly, as explained above, the signal sensed by the incremental sensor 20 is formed from only +/−1^{st} diffraction orders, whereas the signal sensed by the reference mark sensor 122 is formed from only the 0^{th} diffraction order. Accordingly, the signal sensed by the incremental sensor 20 is formed from a diffraction order composition that is different to that of the signal sensed by the reference mark sensor 122.

Without the octadic waveplate 214, what falls on the incremental sensor 20 and reference mark sensor 122 could vary significantly depending on the predominant polarisation orientation emitted by the VCSEL 12. At worst it could mean that the incremental sensor 20 or the reference mark sensor 122 sees no light at all. For instance, in a set up identical to that of FIG. 8 but without the octadic waveplate 214, the incremental sensor 20 would see no light at all if the VCSEL light source 12 emits only vertically polarised light, and the reference mark sensor 122 would see no light at all if the VCSEL light source emits only horizontally polarised light. However, it can be assured that both the incremental 20 and reference mark 122 sensors will receive a decent signal regardless of the polarisation orientation of the light emitted by the VCSEL light source 12, by providing an octadic waveplate 214 and configuring it such that its fast axis is angled with respect to both the polarisation axis of the first polarising filter 120 and the polarisation axis of the second polarising filter 223. For example, arranging the fast axis of the octadic waveplate 214 to be at 45° to the polarisation axis of the first polarisation filter 120 and also at 45° to the polarisation axis of the second polarisation filter 223 means that, for all other factors being equal, the optical power of the signal falling on the incremental sensor 20 and the reference mark sensor 122 will not vary regardless of the polarisation state of the light output by the VCSEL 12. Another way of looking at this is that, of the light leaving the octadic waveplate 214 toward the incremental 20 and reference mark 122 sensors (i.e. after the light has passed through the octadic waveplate 214 for a second time), the ratio of: i) the optical power of light resolvable along the “horizontal” polarisation axis (i.e. along the polarisation axis of the first polarising filter 120), to ii) the optical power of light resolvable along the “vertical” polarisation axis (i.e. along the polarisation axis of the second polarising filter 223), is 1:1. This will be true regardless of the polarisation state of the light output by the VCSEL 12 (because of the 45° angle between the octadic waveplate's fast axis and the polarisation axes of the first 120 and second 223 polarising filters).

As will be understood, other types of sensor could be used instead of the above described electrograting. For example, in embodiments in which modulated spots are created by the readhead's optical system instead of an interference fringe pattern, bulk sensor photodiodes could be used to detect the intensity of the modulated spots.

The above-described embodiments of FIGS. 3 and 8 use a refractive lens 109 to relay the diffraction orders toward the sensors. However, as will be understood, this need not necessarily be the case. For instance, FIG. 13 schematically illustrates an optical system of an encoder apparatus comprising an incremental scale 104 and a readhead 206′ according to another embodiment of the invention which is similar to that of FIG. 8 (and like parts share like reference numerals) except that it does not rely on a refractive lens 109 to relay the diffraction orders toward the sensors. In this embodiment, 0^{th} and +/−1^{st} diffraction orders are produced from the light from the light source hitting and being reflected by the scale 104. As illustrated, the 0^{th} and +/−1^{st} diffraction orders are spatially separate at a first plane pl¹. The diffraction order encoder 216 is located at the first plane pl¹. As per the embodiment of FIG. 11, the diffraction order encoder comprises a 0^{th} order polariser 216a (e.g. having a “vertical” polarisation axis) which coincides with the 0^{th} diffraction order so as to encode the 0^{th} diffraction order with a first (e.g. vertical) polarisation orientation. The diffraction order encoder further comprises a +1^{st} order polariser 216b and −1^{st} order polariser 216c which coincide with the + and −1^{st} diffraction orders. The +1^{st} order polariser 216b and −1^{st} order polariser 216c are configured with the same orientation as each other such that the +/−1^{st} diffraction orders have the same (e.g. “horizontal”) polarisation orientation as each other, but different to the polarisation orientation of the 0^{th} diffraction order. Diffraction gratings G2 are located so as to cause the polarised +/−1^{st} diffraction orders to converge. The 0^{th} diffraction order is not deflected. Accordingly, the 0^{th} diffraction order and the +/−1^{st} diffraction orders meet at a plane pl² at which the incremental 20 and reference mark 122 sensors are located. As per the embodiment of FIG. 8, a first polariser 120 can be located in front of the incremental sensor 20 and can be configured to filter out the 0^{th} diffraction order such that it doesn't reach the incremental sensor 20 and/or a second polariser 223 can be located in front of the reference mark sensor 122 and can be configured to filter out the +/−1^{st} diffraction orders such that they do not reach the reference mark sensor 122. The light source 12 and non-uniform/patterned retarder are omitted from FIG. 13 for sake of clarity of illustration. As will be understood, a separate refractive lens or a grating can be used to collimate light from the light source toward the scale, if desired or necessary.

The embodiments described so far have been in connection with incremental encoders, comprising an incremental scale with (or optionally without) one or more reference marks. The invention can also be used with absolute encoders comprising absolute scale, such that those depicted in FIGS. 14 and 15. In the embodiment of FIG. 14, the absolute scale 504 comprises features arranged notionally periodically, but wherein select features have been removed to encode unique/absolute position data along the measuring length of the scale. The data can be in the form of, for instance, a pseudorandom sequence or discrete codewords. Details of such a scale are described in more detail in U.S. Pat. Nos. 7,499,827 and 5,279,044. The readhead 506 (the body of which is omitted for the sake of clarity) shares some parts which are the same as those described above in connection with the other embodiments of the invention, and therefore like parts share the same reference numeral. For instance, the readhead 506 comprises a VCSEL light source 12, a lens 109, a polarisation manipulator 214 (e.g. the octadic waveplate of the embodiment of FIG. 8), a diffraction order encoder 216, incremental detector 20 and first polarising filter 120, which are configured and arranged in the same manner as that described above in connection with the embodiment of FIG. 8. Accordingly, the 0^{th} order is blocked such that it does not contribute to forming the signal detected by the incremental sensor 20. As with the embodiment of FIG. 8, the first polarising filter 120 has a polarisation axis which is perpendicular to the polarisation axis of the 0^{th} order polariser 216a of the diffraction order encoder 216. In particular, in this embodiment, the 0^{th} order polariser 216a has a vertical polarisation axis and the first polarising filter 120 has a horizontal polarisation axis. Also as per the embodiment of FIG. 8, the fast axis of the octadic waveplate 214 (through which light passes twice on its way from the light source 12 to the sensors 20, 520) is arranged at an angle of 45° to the polarisation axis of the first polariser 120.

In this embodiment, the readhead 506 further comprises an absolute sensor 520, which comprises a photodiode array (in this embodiment a one-dimensional photodiode array, but it could be two-dimensional), on which an image (or “pseudo-image”-see above) falls. As is known, and for example described in U.S. Pat. Nos. 7,499,827, 5,279,044 and 10,989,567, an image of the scale can be processed in order to extract the absolute/unique code so as to thereby determine an absolute position. The absolute position can be combined with the incremental position determined from the incremental detector 20 to provide a fine-pitch absolute position. Optionally, once the absolute position has been determined, subsequent positions can be determined solely by monitoring the output from the incremental detector 20.

Similar to the reference mark embodiments described above, it can be beneficial to allow the 0^{th} order to contribute to the signal falling on the absolute sensor 520. Furthermore, similar to the reference mark embodiments described above it can be beneficial to prevent the +/−1^{st} diffraction orders from contributing to the signal falling on the absolute sensor 520. Accordingly, a second polarising filter 523 can be provided in front of the absolute sensor 520 which has a polarisation axis orthogonal to the polarisation axes of the +1^{st} order 216b and −1^{st} order 216c polarisers of the diffraction order encoder 216. In particular, in this embodiment, the 0^{th} order polariser 216a has a vertical polarisation axis, the +1^{st} order polariser 216b and −1^{st} order polariser 216c have a horizontal polarisation axis, and the second polarising filter 523 has a vertical polarisation axis.

FIG. 15 illustrates another embodiment of an absolute encoder 600 comprising an absolute scale 604, which is substantially identical to that described above in connection with FIG. 14 (and like part share the same reference numeral), except that in this embodiment, the scale comprises a multi-track arrangement wherein absolute code features are provided in absolute scale tracks 603 provided either side of a pure incremental track 605. As shown, the absolute scale tracks 603 also comprise the finer pitch/period incremental features in the spaces between the coarser pitch/period features of the absolute scale tracks 603. As an example, the coarse features of the absolute scale tracks which encode the absolute position information could have a nominal period of approximately 32 μm and the finer pitch/period incremental features can have a period of approximately 8 μm. As a result, there are effectively two sets of diffraction orders produced; a first set of diffraction orders which are produced by the first series of position features (e.g. the 8 μm incremental scale features) and a second set of diffraction orders produced by the second series of position features (e.g. the absolute scale features). As it happens, in this embodiment, the 0^{th} diffraction order of the first set of diffraction orders passes through the 0^{th} order polariser 216a of the diffraction order encoder 216 and the +1^{st} and −1^{st} diffraction orders of the first set of diffraction orders respectively pass through the +1^{st} order polariser 216b and −1^{st} order polariser 216c, whereas the 0^{th} and the +/−1^{st} diffraction orders of the second set of diffraction orders all pass through the 0^{th} order polariser 216a of the diffraction order encoder 216. The higher diffraction orders of the first set of diffraction orders (e.g. the +/−3^{rd}, +/−5^{th} diffraction orders are blocked by the opaque substrate 115). The +3^{rd} and −3^{rd} diffraction orders of the second set of diffraction orders respectively pass through the +1^{st} order polariser 216b and −1^{st} order polariser 216c of the diffraction order encoder 216. Diffraction orders greater than the +/−3^{rd} of the second set of diffraction orders have substantially insignificant power, but what does exist of them will be blocked by the opaque substrate 115. As will be understood, which diffraction orders go through which filter is system dependent and can depend on various factors, including the size and/or position of the polarising filters.

As shown, the sensor arrangement of the embodiment of FIG. 15 is slightly different to that of FIG. 14 in that (similar to the embodiments of FIGS. 3 and 8) the absolute sensor 620 readhead is split into two with the incremental sensor 22 located therebetween. A variation of the embodiment of FIG. 15 is that the absolute scale features extend fully across the incremental scale features (i.e. such that there isn't the track 605 of pure incremental scale between two absolute tracks 603). Rather, the absolute scale features can be fully embedded across the entire incremental features like that of FIG. 14. In this case, the above comments regarding the two set of diffraction orders still apply due to the incremental and absolute position features having different nominal periods in this embodiment. If desired, in alternative configuration, the incremental sensor 20 and absolute sensor 620 can be arranged as per the embodiment of FIG. 14 (i.e. two sensors side-by-side).

The embodiments described above utilise a lensless or a single-lens system through which the light from the light source passed on its way toward and back from the scale. As will be understood, other optical configurations are possible, such as that schematically illustrated in FIG. 16 (which also happens to illustrate an absolute encoder apparatus comprising an absolute scale). The encoder 300 of FIG. 16 comprises an absolute scale 304 which comprises features arranged notionally periodically, but wherein select features have been removed to encode unique/absolute position data along the measuring length of the scale. The data can be in the form of, for instance, a pseudorandom sequence or discrete codewords. Details of such a scale are described in more detail in U.S. Pat. Nos. 7,499,827 and 5,279,044. The readhead 306 (the body of which is omitted for the sake of clarity) shares some parts which are the same as those described above in connection with the other embodiments of the invention, and therefore like parts share the same reference numeral. For instance, the readhead 306 comprises a polarised VCSEL light source 12 and a ¼ waveplate 14. A first lens 309 is provided which collimates light from the VCSEL 12. An optical beam-splitting member 307 is provided for enabling light from the VCSEL 12 to pass through to the scale 304 to illuminate it and to redirect light reflected by the scale back toward a sensor 320 (in this case a one-dimensional array of photodiodes, e.g. a complimentary metal-oxide-semiconductor “CMOS” sensor) which is configured to sense an image of the scale formed thereat by the second lens 310. In this embodiment, the sensor 320 has an integral polarisation filter (not shown) such that the sensor 320 senses light filtered along the polarisation axis of the integral polarising filter. The readhead is configured such that the angle between the fast axis of the ¼ waveplate 14 and the polarisation axis of the integral polarisation filter is 45°. As per the embodiments described above, the angle doesn't have to be at 45°, but such an angle can be preferred. The image obtained by the sensor 320 can be processed by a processor device to determine the relative position of the readhead 306 and scale 304 in a known way (e.g. as described in U.S. Pat. No. 10,989,567).

FIG. 17 illustrates another example embodiment according to the present invention. In this embodiment, except for the use of a polarised light source 12, the polarising filter 120, and the polarisation manipulator 14 (in this embodiment a ¼ waveplate), the configuration and operation of the encoder according to this embodiment is substantially identical to that described in WO2005124282. Accordingly, putting the polarisation manipulator 14 to one side for the moment, light from the light source 12 illuminates a region 24 of the scale 4. Owing to the periodic arrangement of the incremental features 10, the light reflected by the incremental features 10 are diffracted into diffraction orders (i.e. in the same way as that described above in connection with FIGS. 1a, 1b). The diffracted light hits the diffraction grating 16, where the light is diffracted into further diffraction orders, which recombine at incremental sensor 20) to form an interference fringe pattern (or “fringe field”) thereon. Movement of the readhead 6 relative to the scale 4 causes movement of the interference fringes relative to the incremental sensor 20 thus producing an up/down count which enables a measurement of displacement. As per earlier described embodiments, the incremental sensor 20 is in the form of an electrograting, and the light source 12 is a VCSEL.

When the readhead 6 passes over the reference mark 11 a change in the intensity of light reflected by the scale 4 is imaged by an optical imaging element lens 18 onto the reference mark sensor 22. In this embodiment, the reference mark sensor 22 comprises a split detector comprising first 22a and second 22b photodiodes onto which light from the scale 4 is imaged. The optical imaging element 18 illustrated in FIG. 17 is a Fresnel Zone Plate. However other types of optical imaging element having the same optical function may be used, for example a refractive lens. As described in, WO2005124282, the reference mark sensor 22 could be partially, or fully embedded within the incremental sensor 20 (and similarly the optical imaging element 18 could be partially or fully embedded within the diffraction grating 16).

In contrast to the embodiments of WO2005124282, a polarising filter is used to filter light reaching the incremental sensor. Accordingly, as per the embodiments described above, without the ¼ waveplate 14, what falls on the incremental sensor and reference mark sensor 22 will vary depending on the predominant polarisation state/orientation emitted by the VCSEL 12. At worst it could mean that the incremental sensor 20 sees no light at all. However, it can be assured that the incremental sensor 20 will receive a decent signal regardless of the polarisation orientation of the VCSEL light source 12, by providing the ¼ waveplate 14 in the optical path between the light source 12 and incremental sensor 20, and configuring it such that its fast axis and the polarisation axis of the polarising filter 120 of the incremental sensor 20 are angled with respect to each other. For example, arranging the fast axis of the ¼ waveplate 14 to be at 45° to the polarisation axis of the incremental sensor's polarisation filter 120 means that, for all other factors being equal (e.g. for a constant optical power output from the VCSEL 12), the optical power of the signal falling on the incremental sensor 20 will be the same regardless of the polarisation state of the light output by the VCSEL 12.

The above-described embodiments use a waveplate 14, 214 as the polarisation manipulator. Other types of optical elements could be used in place of a waveplate, such as a diffuser, a non-uniform/patterned retarder, or a time-based polarisation manipulator. As will be understood, in the case of a time-based polarisation manipulator, the rate of modulation would need to be faster than the acquisition bandwidth of the encoder's sensor(s). Typically, a rate of at least 1 MHz should be sufficient. Fibre-coupled time-based polarisation scramblers exist, such as those available from FIBREPRO Inc which would be suitable for a fibre-optic type position encoder. A spatial polarisation manipulator, in particular a non-uniform/patterned retarder has been found to be preferred because time-based manipulators require electronics that may not be conducive to a compact encoder, and depending on the embodiment, a diffuser may provide adverse significant deflection of rays, which adversely affect the formation of an interference fringe pattern.

As mentioned, a non-uniform/patterned retarder could be used as a polarisation manipulator instead of the above described ¼ or octadic waveplates. FIG. 18 illustrates an example suitable non-uniform/patterned retarder 414 for use in place of the ¼ waveplate 14 used in the embodiment of FIG. 17.

In this embodiment, the patterned retarder 414 comprises a non-uniform fast axis along the Y-dimension, which is orthogonal to the encoder's measuring dimension (X) (hence, why it could be described as being a “non-uniform retarder” or “patterned retarder”). In particular, the patterned retarder 414 comprises an array of discrete elongated half-waveplate pixels/rows 19, wherein the array extends in the Y-dimension, and the elongate length of the pixels/rows extends in the X-dimension. Accordingly, the array/series of pixels extends perpendicular to the measuring dimension (X) of the scale 4. Accordingly, in this embodiment the patterned retarder 414 does not comprise any structure in the measuring (X) dimension. This can be advantageous so as to prevent the patterned retarder 414 being a source of diffraction of light in the X-dimension, which could otherwise adversely interfere with the generation of the optical signal at the sensors 20, 22. However, as will be understood, in other embodiments/applications, such diffraction might be tolerable and therefore the non-uniform/patterned retarder could comprise structure in the X-dimension, e.g. it could be arranged such that the array/series of retarder pixels extends along the Y-dimension, or the non-uniform/patterned retarder could comprise a two dimensional array of retarder pixels.

As shown in FIG. 18(a), the half-waveplate pixels 19 are arranged with alternating fast axes of 0° and 45°. Such a configuration ensures that regardless of the predominant input polarisation orientation of the footprint 21 of light hitting the patterned retarder 414, the light output from the patterned retarder 414 will have a mix of polarisation orientations across its extent/footprint (in the Y-dimension) such that the DOP of the light leaving the patterned retarder 414 will be less than the DOP of the light hitting the patterned retarder 414. In particular, in this embodiment, the light output from the patterned retarder 414 will comprise (in the Y-dimension) alternating sections/portions/rows of light having two different polarisation orientations that are always orthogonal to each other, regardless of the predominant input polarisation orientation. Therefore, it is guaranteed that regardless of the polarisation state of the light emitted from the polarised light source 12, light that leaves the patterned retarder 414 toward the incremental sensor will have a polarisation state which is at least partially resolvable along polarisation axis of the first polarising filter 120. Furthermore, in the embodiment described, the light output from the patterned retarder 414 will comprise a balanced mix of polarisation orientations (e.g. in this embodiment there will be substantially equal amounts of the two different orthogonal polarisation orientations).

Accordingly, the patterned retarder 414 is configured such that the optical power (e.g. in milliwatts, “mW”) of the light within the footprint of light 21 output from the patterned retarder 414 will be substantially equal along orthogonal polarisation axes, irrespective of the orientation of the orthogonal polarisation axes (accordingly, the DOP of the footprint of light 21 output from the optical retarder element will be close to 0, e.g. not more than 0.1, and preferably not more than 0.02). This can be beneficial for reasons of balance and consistency of performance of the encoder. For example, if the optical power along one polarisation axis is substantially greater than that of another orthogonal polarisation axis, the effects of polarisation on the encoder performance might not suppressed as much as a configuration where the optical powers of the light along orthogonal polarisation axes were substantially the same, especially if their respective powers changed with a change in the input polarisation orientation.

With reference to FIG. 18(b) there are shown four different (i-iv) example orientations of orthogonal polarisation axes (v, h) and a graph of the optical power along those orthogonal polarisation axes of the light output from the patterned retarder 414 within the footprint of light 21. As shown, due to the substantially balanced mix of polarisation orientations output by the patterned retarder 414 within the footprint of light 21, for any pair of orthogonal polarisation axes, the optical power along each of the polarisation axis is substantially the same irrespective of the orientations of the orthogonal polarisation axes. In other words, within the footprint of light 21 output from the patterned retarder 414, if the light output from the patterned retarder 414 were polarised along a first polarisation axis, the optical power of the polarised light would be substantially the same as the optical power of light if it were instead polarised along a second polarisation axis that is orthogonal to the first polarisation axis.

The patterned retarder 414 is configured such that, within at least the region of the footprint of light output from the patterned retarder 414 that forms the optical signal at the sensor, and regardless of the predominant input polarisation state of the light hitting the optical retarder element, the difference in the optical powers along orthogonal polarisation axes of the output beam is at least half that of the input beam, irrespective of the orientations of the orthogonal polarisation axes.

In the embodiments described herein, substantially equal (or “substantially the same”) optical powers along the orthogonal polarisation axes means that the difference in optical power along the orthogonal polarisation axes varies by no more than 2% of the total power. Accordingly, in such a case the DOP of the light output from the patterned retarder 414 within the footprint of light 21 is not more than 0.02 or 2%. However, as will be understood, in other embodiments, such a tight tolerance might not be required and so substantially equal (or “substantially the same”) optical powers of the light along the orthogonal polarisation axes could mean that the difference in optical power along the orthogonal polarisation axes varies by no more than 5% of the total power, for instance varies by no more than 10% of the total power, for example varies by no more than 20% of the total power. In other words, the patterned retarder 414 could be configured such that the DOP of light output from the optical retarder element within the footprint of light 21 is not more than 0.05 (or 5%), for instance not more than 0.1 (or 10%), for example not more than 0.2 (or 20%).

As shown in FIG. 18(a), the pitch p of the half-waveplate pixels 19 is substantially smaller than the width of the patterned retarder 414 in the Y-dimension. In particular, although it is possible that the patterned retarder 414 only comprises two pixels (such that a first half of the light output therefrom has one polarisation orientation and a second half of the light output therefrom has a different, orthogonal polarisation orientation), it has been found beneficial to provide the patterned retarder 414 with a substantially higher number of half-waveplate pixels 19 so as to spread the different polarisation orientations across the footprint of light output from the patterned retarder 414, and therefore across the scale features on the scale 4 (rather than the same or similar polarisation orientations all being grouped to one side). This can be beneficial for a number of reasons, including providing greater freedom for where the sensors can be positioned along the Y-dimension and still receive the benefit of the invention. In this embodiment, this is achieved by providing the patterned retarder 414 with a plurality of half-waveplate pixels 19 of alternating fast axes. In particular the ratio of the pitch p₁ of the half-waveplate pixels 19 to the width Wᵣ of the patterned retarder 414 (in the dimension along which the series of pixels extend—in this embodiment along the Y-dimension) is at least 1:4, more preferably at least 1:10, especially preferably at least 1:20, for example at least 1:30.

Note that in this embodiment the arrangement of the half-waveplate pixels 19 is such that the above statements about the optical power along orthogonal polarisation axes of the light output from the patterned retarder 414 within the footprint of light 21 being substantially the same (and the statements about the DOP of the light output from the patterned retarder 414 within the footprint of light 21 being below a certain level), is also true for the region 21a of the footprint of light output from the patterned retarder 414 that is directs toward the incremental sensor 20, and it is also true for the region 21b of the footprint of light output from the patterned retarder 414 that is directed toward the reference mark sensor 22.

Further still, in the embodiment described, the patterned retarder 414 is configured such that the different polarisation orientations output within the region 21a are substantially evenly distributed in Y-dimension (i.e. perpendicular to the measuring dimension X), such that, for a notional division of the region into a one-dimensional array of two rows (21aa and 21ab) of equal width, the array extending parallel to the Y dimension, the optical power along orthogonal polarisation axes of the light output from the patterned retarder 414 within each of said two rows as, is substantially equal irrespective of the orientations of the orthogonal polarisation axes. Note that this is also the case for the region 21b of the footprint of light output from the patterned retarder 414 that forms the optical signal at the reference mark sensor 22 (e.g. for a notional division of the region into a one-dimensional array of two rows 21ba and 21bb of equal width, the array extending parallel to the Y dimension, the optical power along orthogonal polarisation axes of the light output from the patterned retarder 414 within each of said n rows as, is substantially equal irrespective of the orientations of the orthogonal polarisation axes). Accordingly, the graphs (i to iv) of FIG. 6(b) (and the above statements about the DOP of the light output from the optical retarder element within the footprint of light 21 being below a certain level) equally apply to each of the rows 21aa and 21ab of the region 21a of the footprint of light output from the patterned retarder 414 that forms the optical signal at the incremental sensor 20, and also equally apply to each of the rows 21ba and 21bb of the region 21b of the footprint of light output from the patterned retarder 414 that forms the optical signal at the reference mark sensor 22. Such a configuration can help to suppress errors that might otherwise be caused by imperfections of the scale features along their lengths. Furthermore, uniform illumination across the sensor can be beneficial. For example, the sensor could be shaped/windowed/weighted to improve the signal output by the sensor, e.g. as described in U.S. Pat. No. 10,670,431, and uniform illumination can be needed to maintain the benefit/effect of the shape/window/weighting.

The above described patterned retarder 414 has been found to be suitable for use in place of the ¼ waveplate used in those embodiments in which light from the light source passes through polarisation manipulator once (such as the embodiments of FIGS. 3, 16 and 17) but less suitable as a replacement of the octadic waveplate used in those embodiments in which the light from the light source passes through polarisation manipulator twice (such as the embodiments of FIGS. 8, 14 and 15). Indeed, it has been found that the polarisation orientation of the light returning through the patterned retarder 414 of FIG. 18(a) for a second time would be altered for a second time, leading to many of the sections/portions of light having their polarisation “undone”. This can result in the light output from the patterned retarder 414 after its second pass therethrough having an uneven mix of polarisation orientations which can be undesirable, in turn resulting in the light after its second pass still having a predominant polarisation orientation which may or may not be at least partially resolvable along the polarisation axis of the sensor's polariser (e.g. the first polarising filter 120).

The inventors identified that for a double-pass system, the mix of polarisation orientations leaving the patterned retarder for the second time can be made more evenly balanced (and therefore ensure that the light that leaves the patterned retarder toward the incremental sensor 20 will have a polarisation state which is at least partially, and more desirably substantially, resolvable along polarisation axis of the first polarising filter 120) by providing a patterned retarder having half-waveplate pixels which are arranged with their differing fast-axes in an aperiodic arrangement. Whilst a random aperiodic arrangement was found to typically provide an improvement of a periodic arrangement, the inventors found that some aperiodic arrangements of fast-axes are better than others at providing a balanced mix of polarisation orientations after the second pass therethrough, regardless of the predominant input polarisation orientation of the footprint of light initially hitting the patterned retarder from the VCSEL 12.

FIG. 19 illustrates an example patterned retarder 514 which is suitable for use in a double-pass configuration and can provide a suitably balanced mix of polarisation orientations after the light has passed through it a second time. The below table lists the fast axis orientations for each of the sixty pixels that make up the non-uniform/patterned retarder 514:

| | Fast axis orientation |
|---|---|
| | (degrees) relative to |
| Pixel # | horizontal axis |
| 1 | 70 |
| 2 | 173 |
| 3 | 4 |
| 4 | 171 |
| 5 | 164 |
| 6 | 168 |
| 7 | 136 |
| 8 | 10 |
| 9 | 39 |
| 10 | 159 |
| 11 | 12 |
| 12 | 151 |
| 13 | 7 |
| 14 | 77 |
| 15 | 161 |
| 16 | 173 |
| 17 | 177 |
| 18 | 52 |
| 19 | 26 |
| 20 | 32 |
| 21 | 168 |
| 22 | 165 |
| 23 | 51 |
| 24 | 13 |
| 25 | 179 |
| 26 | 92 |
| 27 | 120 |
| 28 | 176 |
| 29 | 111 |
| 30 | 145 |
| 31 | 6 |
| 32 | 51 |
| 33 | 152 |
| 34 | 178 |
| 35 | 66 |
| 36 | 144 |
| 37 | 57 |
| 38 | 42 |
| 39 | 2 |
| 40 | 3 |
| 41 | 169 |
| 42 | 158 |
| 43 | 11 |
| 44 | 103 |
| 45 | 57 |
| 46 | 166 |
| 47 | 159 |
| 48 | 36 |
| 49 | 169 |
| 50 | 77 |
| 51 | 1 |
| 52 | 179 |
| 53 | 57 |
| 54 | 168 |
| 55 | 73 |
| 56 | 88 |
| 57 | 2 |
| 58 | 3 |
| 59 | 7 |
| 60 | 132 |

Accordingly, as shown, in this embodiment, the patterned retarder 514 comprises a plurality of (in this embodiment, sixty) half-waveplate pixels 119 having more than two different fast-axes orientations, and they are not arranged periodically.

Of course, the above arrangement of fast-axes is not the only arrangement which can provide a substantially balanced mix of polarisation orientations are output from the non-uniform/patterned retarder 514 after the light has passed through it twice. Other arrangements are possible and can be chosen by the designer of the optical encoder system.

The use of the terms “pattern” and “patterned” in this document, especially in connection with the polarisation manipulator, is not intended to imply that the presence of any sort of repeating configuration. Rather, the terms “pattern” and “patterned” are used to confer that the polarisation manipulator, e.g. the retarder, has a non-uniform design/form.

The invention is described above in connection with linear encoder apparatus. However, the invention is equally applicable to rotary encoder apparatus, including both ring encoders (wherein the scale features are formed on the outer cylindrical surface of a ring member) and disc encoders (wherein the scale features are formed on the planar face of a disc member).

In the embodiments described, the light source 12 emits electromagnetic radiation (EMR) in the near infra-red range. However as will be understood, this need not necessarily be the case and the light source 12 could emit EMR in other ranges, for example anywhere in the infra-red to the ultra-violet. As will be understood, the choice of a suitable wavelength for the light source 12 can depend on many factors, including the availability of suitable gratings and detectors that work at the EMR wavelength.

The waveplates of the above-described embodiments could comprise birefringent material, such as quartz, mica, or liquid crystal. Optionally, the waveplates of the above-described embodiments could comprise structures configured to provide birefringent-like properties, such as metamaterials. For example, it is known that nanocasting lithography can be used to provide a waveplate.

In the embodiments described above, the scale is a reflective scale. However, this need not necessarily by the case. For instance, the scale could be a transmissive scale, wherein the light source and sensors are located on opposing sides/faces of the scale.

1. A position measurement encoder apparatus comprising:
a scale comprising a series of position features which are readable by a readhead; and
a readhead comprising:
i) a polarised light source for emitting polarised light toward the scale;
ii) a first sensor configured to sense light filtered along a first polarisation axis, the first sensor being arranged to sense light from the polarised light source that has interacted with the scale; and
iii) a polarisation manipulator, located in the optical path between the polarised light source and the first sensor, configured such that regardless of the polarisation state of the light emitted from the polarised light source, light that leaves the polarisation manipulator toward the first sensor will have a polarisation state which is at least partially resolvable along the first polarisation axis.

2. The apparatus as claimed in claim 1, configured such that of the light leaving the polarisation manipulator toward the first sensor, the ratio of: i) the optical power of light resolvable along the first polarisation axis, to ii) the optical power of light resolvable along a second orthogonal polarisation axis, is at least 2:3.

3. The apparatus as claimed in claim 1, configured such that for all other factors being equal, the optical power of light sensed by the first sensor is substantially the same for all possible polarisation orientations of the light emitted from the polarised light source.

4. The apparatus as claimed in claim 1, in which the readhead additionally comprises:
iv) a second sensor configured to sense light filtered along a second polarisation axis, the second sensor being arranged to sense light from the polarised light source that has interacted with the scale;
in which the polarisation manipulator is configured such that regardless of the polarisation state of the light emitted from the polarised light source, light leaving the polarisation manipulator toward the second sensor will have a polarisation state which is at least partially resolvable along the second axis.

5. The apparatus as claimed in claim 4, in which the second polarisation axis is orthogonal to the first polarisation axis.

6. The apparatus as claimed in claim 4, configured such that, for all other factors being equal, the optical power of light sensed by the first sensor is substantially the same for all possible polarisation orientations of the light emitted from the polarised light source, and the optical power of light sensed by the second sensor is substantially the same for all possible polarisation orientations of the light emitted from the polarised light source.

7. The apparatus as claimed in claim 1, in which the polarisation manipulator comprises a waveplate, and in which the effective total wave retardance of the polarisation manipulator is n+¼, where n is an integer ≥0.

8. The apparatus as claimed in claim 7, in which the waveplate is arranged such that its fast axis is arranged at an angle of between 30° and 60° to the first polarisation axis.

9. The apparatus as claimed in claim 1, in which the light from the light source passes through the polarisation manipulator twice in its path from the light source to the first sensor.

10. The apparatus as claimed in claim 7, in which the polarisation manipulator comprises an octadic waveplate-waveplate, and the light from the light source passes through the polarisation manipulator twice in its path from the light source to the first sensor

11. The apparatus as claimed in claim 1, in which:
the scale's position features diffract the light into multiple diffraction orders;
at least one of the diffraction orders has a polarisation state different to that of at least one other diffraction order.

12. The apparatus as claimed in claim 11, configured such that, due to the first sensor being configured to predominantly sense light filtered along a first polarisation axis, the signal sensed by the first sensor is predominantly formed from a select subset of diffraction orders.

13. The apparatus as claimed in claim 3, configured such that, by way of:
the polarisation state of the diffraction orders;
the first sensor being configured to sense light filtered along a first polarisation axis; and
the second sensor being configured to sense light filtered along a second polarisation axis,
the light sensed by the first sensor comprises a diffraction order composition that is different to that of the light sensed by the second
in which the scale's position features diffract the light into multiple diffraction orders; and
at least one of the diffraction orders has a polarisation state different to that of at least one other diffraction order.

14. A position measurement encoder apparatus comprising:
a scale comprising a series of position features which are readable by a readhead;
a readhead comprising:
i) a polarised light source for emitting polarised light toward the scale;
ii) a first sensor configured to sense light filtered along a first polarisation axis, the first sensor being arranged to sense light from the polarised light source that has interacted with the scale;
iii) a waveplate, located in the optical path between the polarised light source and the first sensor, in which the effective total wave retardance of the waveplate is n+¼, where n is an integer ≥0, and which is arranged such that its fast axis is arranged at an angle of between 30° and 60° to the first polarisation axis.

15. The position measurement encoder apparatus as claimed in claim 14, comprising:
iv) a second sensor configured to sense light filtered along a second polarisation axis that is orthogonal to the first polarisation axis, the second sensor being arranged to sense light from the polarised light source that has interacted with the scale.

16. The position measurement encoder apparatus as claimed in claim 14, in which the waveplate comprises an octadic waveplate, and wherein the light from the light source passes through the octadic waveplate twice in its path from the light source to the first sensor.

17. A position measurement encoder apparatus as claimed in claim 16, in which the waveplate comprises an octadic waveplate, and wherein the light from the light source passes through the octadic waveplate twice in its path from the light source to the first and second sensors.

18. A position measurement encoder apparatus as claimed in claim 15, in which:
the scale diffracts the light into multiple diffraction orders; and
the readhead comprises a diffraction order encoder configured to:
encode the 0^{th} diffraction order with a polarisation state that is aligned with the second polarisation axis, and
encode the +/−1^{st} diffraction orders with a polarisation state that is aligned with the first polarisation axis;
such that the first sensor senses the +−/1^{st} diffraction orders but not the 0^{th} diffraction order and the such that the second sensor senses the 0^{th} diffraction order but not the +/−1^{st} diffraction orders.
